(19) United States
(12) Patent Application Publication
(10) Pub. No.: US 2008/0277492 A1
(43) Pub. Date: Nov. 13, 2008

(54) FLUID PROPERTY REGULATOR

(76) Inventor: David J. Cannon, State College, PA (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/118,668

(22) Filed: May 9, 2008

Related U.S. Application Data
(60) Provisional application No. 60/917,629, filed on May 11, 2007.

(51) Int. Cl. A01G 15/00; F03G 7/05

(52) U.S. Cl. 239/14.1; 239/2.1; 60/641.7

(57) ABSTRACT

A self-sufficient material property profile regulation method and system, for adjusting fluid property profiles such as in an ocean of multiple property layers, is described. Using this Fluid Property Regulator, the property profiles of a non-enclosed material, including property profiles related to material density, chemical characteristics and space-time position, are affected due to motion of the material relative to a body in the flow stream. The state of other matter with which the initial material then makes direct or indirect contact is also affected. For example, in the case of a liquid such as an ocean current, the temperature, salinity, nutrient content and other properties may be destratified (i.e. layers being combined) as the system lifts large quantities of deep water and combines this material with surface water in the downstream far-field region of the system. The resulting regulation of such ocean water property profiles may then also indirectly affect the properties of the atmosphere above the ocean so that the system can be said to affect planetary properties both oceanic and atmospheric. Rather than merely discharging a pumped material, such as cold water that might quickly re-submerge, the system regulates lasting property profiles. The new Fluid Property Regulator system described in this invention regulates material properties to produce desired outcomes such as increased food and energy production as well as to prevent undesirable outcomes such as hurricanes, elevated planetary temperatures, decreased planetary ice sheet size, raised sea level and glacial freshwater incursions that can halt important major currents.

### CROSS-REFERENCE TO RELATED APPLICATIONS

This application claims the benefit of U.S. Provisional Patent Application No. 60/917,629, which is incorporated herein by reference.

### STATEMENT REGARDING FEDERALLY SPONSORED RESEARCH OR DEVELOPMENT

Not applicable

### REFERENCE TO A MICROFICHE APPENDIX

Not applicable

### FIELD OF THE INVENTION

This invention relates generally to material property regulation and in particular to the use of relative motion between a body and surrounding material to produce direct regulation of the properties of external flow materials as well as the indirect regulation of properties of more distant secondary target flow materials.

### BACKGROUND OF THE INVENTION

Water currents naturally occur in oceans and rivers. Since the days of sailing vessels, such currents as the Gulf Stream Current have been tracked by ship captains to expedite travel time in the presence of water flow velocity. Watermills have also been used throughout history to harness power for tasks from grinding flour to driving textile manufactories.

The study of water flow regulation suggests the use of regulation in controlling water flow rate, but flow rate is not an inherent characteristic property of a material and flow rate control involves conduits or other enclosing surfaces. There remains a need to regulate actual material property profile characteristics by relative external movement that does not make use of artificial conduits or enclosures. The patent entitled “Flow Regulator and Corresponding Method with Pressure Responsive Flow Regulation” (U.S. Pat. No. 6,213,408) is an example of a regulator for controlling flow rate alone. In that patent, leaf-spring portions are said to be configured to cooperate with an adjacent surface to provide multiple-stage pressure-responsive flow regulation. But such pressure responsive flow regulation merely regulates flow rate, and does not claim to cause material property regulation in the downstream far-field using a body in motion relative to an external material. Furthermore, such regulation involves artificial conduits with enclosure surfaces that channel the flow as the flow rate is regulated. There remains a need for a method of material property profile regulation, using a body in motion relative to an external material, that does not rely on conduits and enclosures around such a body and that causes actual material property regulation of the external material profile including such regulation as temperature profile regulation, salinity profile regulation, nutrient profile regulation and other such regulation of inherent material properties.

The study of hurricane damage control suggests the use of jet airplanes to inject super-cooled material into hurricanes, but there remains a need to reduce hurricane damage by using external material property regulation in the downstream far-field of a material, such as an ocean, using relative motion between a body and an external material. The patent entitled “Tropical Hurricane Control System” (U.S. Patent Publication 20070158449) is an example of a possible method for hurricane damage control that suggests spraying a super coolant such as liquid oxygen around the top of the eye wall of a hurricane to reduce/eliminate the damage to life and property. But the eye-wall spraying invention does not claim the use of a body in motion relative to an external material to cause regulation of material property characteristics in the downstream far-field.

Other patents have considered various ocean phenomena for the generation of power, which may be drawn upon by the present invention for system self-sustainment at sea, but these methods do not use the relative motion between a body and a fluid material to achieve desired material property regulation in the downstream far-field. The patent entitled “Integrated OTEC Platform” (U.S. Pat. No. 7,328,578), for example, utilizes a cold water circuit to generate electricity while adjusting the buoyancy of the platform such that the collectors are about level with the sea level to minimize pumping requirements. Such a concept is related to energy self-sustainment and production aspects of the present Fluid Property Regulator invention—and may, if implemented as a supporting feature, provide a small quantity of cold water feed into the external flow of the present Fluid Property Regulator system. However, the method of external material flow relative to a body for material property regulation is not claimed in the OTEC patent and any concentrated cold water discharge from such a facility will submerge quickly without long term effect unless incorporated into the present invention. There remains a need to regulate fluid properties by fluid flow around a body in a flow stream as a method for substantial and sustainable fluid property regulation.

Upon further scrutiny, it also appears prohibitively difficult to adapt conventional internal-flow piping technology to achieve water property regulation for large applications such as hurricane regulation and subsequent atmospheric temperature regulation. Vacuum vaporization cavitations and pipe wall collapse problems, for example, are factors that render the adaptation of presently available internal pipe conduit technologies costly and insufficient. While internal-flow piping may be effectively used for supplementary purposes related to the present fluid property regulation invention, (e.g. one embodiment for the present Fluid Property Regulator system introduces a particular double-wall pipe design for small supplementary flow needs), there remains a need for a broader method of creating large-scale external-flow around a body to achieve material property regulation without conduits and enclosing surfaces. The new external-flow concept essentially creates flow around a large, inexpensive, water filled bag, as the primary feature of the new material property regulation system. Large quantities of deep water simply flow up from below such a body due, for example, to a high Reynolds number relationship between effective body diameter, velocity and viscosity. Such external flow around a body in a flow stream as a method for substantial and sustainable fluid property regulation is not described in existing literature.

In terms of hurricane regulation, in particular, although the connection has not previously been made between hurricane regulation and the features of fluid flow around a body, an understanding has been well established that the natural generation of hurricanes requires the existence of ocean surface temperatures above approximately 80 degrees Fahrenheit throughout approximately the top 200 feet of ocean water. The regulation of water properties to produce cooler surface water conditions than these overheated conditions would therefore be logically accepted by climatologists as sufficient to achieve the proposed hurricane dissipation objective despite a lack of direct references in existing literature.

Many features of the present Fluid Property Regulator invention are not similar in any apparent way to features of other patents. For example, the self-propelled multi-layer material profile regulation embodiments of this Fluid Property Regulator invention, to specifically regulate regions of distinct density and nutrient profiles, such as the Sargasso Sea, and thereby lower atmospheric temperature, reduce glacial melting, reduce glacial movement velocity, increase the amount of precipitation that falls on ice sheets in the form of snow, and avoid Gulf Stream stoppages due to interference from low-density glacial run-off, all by external flow around one or more large profile-spanning body of the present Fluid Property Regulator system is unique. There appears to be no parallel for comparison in the patent literature.

Descriptions of the thermodynamics and dynamics of fluid flow in liquids such as an ocean and gases such as an atmosphere are given in Engineering Thermodynamics by Reynolds and Perkins (1970), Dynamics and Thermodynamics of Compressible Fluid Flow by Shapiro (1953), and Dynamics and Thermodynamics of Compressible and Incompressible Fluid Flow, by NASA (1990).

### SUMMARY OF THE INVENTION

A semi self-sufficient fluid property regulation system and apparatus, for adjusting the properties of materials such as fluid property profiles in a stratified ocean current, based on the far-field property alteration effects of bodies in a flow stream, is disclosed. The bodies of the system are either moored, such as in the property stratified flow stream of a moving multi-layered liquid such as an ocean current, or the bodies are self-propelled such as in the case where there is a reduced flow stream and the system plies a region such as the Sargasso Sea between North Africa and North America in the Atlantic Ocean. Relative motion exists, in either the moored or self-propelled embodiments, due to flow of the surrounding material around at least one body. At high Reynolds numbers in particular, (e.g., where the relationship between velocity times effective body diameter divided by viscosity is several orders of magnitude larger than unity), material from one portion of the flow will combine with material from other portions of the flow to cause material property profile regulation.

There is a particular type of fluid property profile regulation, such as involving flow currents in open oceans, based on use of a system of at least one body, where external flow relative to the system causes desired material property profile regulation in the downstream far-field of a flow stream. This “Fluid Property Regulator system” is defined as including at least one body that uses either self-propulsion or the attachment of at least one mooring line to at least one external reference point, to cause material property regulation due to relative motion between the system and a flow stream in the absence of manufactured conduits or enclosing structures. Either the self-propulsion subsystem or the adjustment of the configuration of the mooring attachments to external reference points can be used to cause the desired amount of relative motion between the system and a spatially variable flow stream.

The one or more bodies may be made of steel, reinforced concrete or other material such as a flexible fabric that is filled with a fill material, such as seawater, at slightly elevated pressure to cause the body to maintain a form that is able to resist impinging forces due to relative motion such as from external ocean currents. The body of the system is suspended in the surrounding material, such as an ocean or other fluid, and may employ a buoyancy collar, vanes or other lifting mechanisms, as well as kite-like vanes and keels, to keep the body at a particular position and elevation in the flow stream. The body of the system is deployed to induce fluid transfer and/or to create particular kinds of property regulation such as de-stratification of fluid properties in the far-field downstream from the body, thus affecting material properties such as temperature, salinity and nutrient profiles for periods of extended duration downstream from the system.

The Ocean Resource Balancing (ORB) approach of this Fluid Property Regulator invention focuses on raising a portion of the ocean's deep water, which is cold and/or nutrient-rich, by way of external fluid flow around a body, so that water property profile regulation can be achieved in the far-field region downstream from the body in a flow stream. One use of the technology is to moderate temperature extremes in localized hot spots of the ocean that cause hurricanes, and subsequently to introduce nutrients for fishing and plant production for food, energy and long-term carbon fixation purposes. As oceanic temperatures are ultimately regulated, using the present Fluid Property Regulator technology, so atmospheric temperatures will be indirectly regulated, thus restoring polar ice caps to sufficient size (and thus sufficient solar reflectivity) to avoid undesirable planetary warming and sea level rise.

A String-of-Pearls implementation of the ORB technology, employing several connected orb bodies as an example application of the material property regulation system of this invention, will take energy from ocean currents—as well as from waves, temperature differentials, marine plants, solar, tidal and other energy alternatives—to regulate fluid (e.g. water and air) properties as needed to adjust temperature levels and other properties of nearby materials such as the water in ocean currents while remaining energy self-sufficient. The central component of each String-of-Pearls implementation is a moored (or self propelled) fluid barrier of spherical, cylindrical or other shape (hereinafter referred to as an orb) that causes turbulent fluid flow when moored in a flow stream or propelled in an otherwise static ocean environment. In an ocean current, for example, a String-of-Pearls implementation will cause cool deep water to combine with warm surface water as water passes over, under and around the archipelago of barriers in high Reynolds number (e.g. trans-critical) fluid flow conditions. A String-of-Pearls implementation will thus cause fluid properties, such as temperature and nutrient content, to be altered (averaged in the case of temperature stratification in the original current) due to ensuing fluid flow regulation downstream from the material property regulator (i.e. String-of-Pearls) installation.

By making use of the nature of high Reynolds number (e.g. trans-critical) fluid flow, the Fluid Property Regulator system of this invention is able to regulate fluids such as the surface of an ocean for large-scale uses such as hurricane regulation and large-area marine plant material production plus other food, energy, climate and planetary uses.

Each aspect of the new material property regulation system of this invention implements a method and/or apparatus that provides a device for regulating variable-property fluid types such as water having a density profile, a temperature profile, a salinity profile and/or a nutrient profile from various stratification layers, such as from different ocean depths, for purposes that are useful for food and energy production in the short term and which ultimately rise to provide achievable hurricane regulation and viable global warming regulation in the future.

Hurricane Katrina, in a particularly destructive display of unregulated ocean surface water properties, is attributed with over $200 billion in damages and the deaths of over 1700 people due to the fact that energy from excessively warm surface water in a small localized area within the Gulf of Mexico energized high-speed winds that brought massive storm surge and considerable damage to one coast of the United States. Methods and embodiments of this Fluid Property Regulator invention may contribute to a regulation of seawater properties, if correctly deployed, to avoid such deleterious effects as elevated local Inner Loop temperatures above 80 degrees Fahrenheit in the top 200 feet of such an ocean area that now frequently causes hurricanes.

For initial implementations, the floating orb platforms at sea may be profitable as energy platforms. As an archipelago of individually viable energy orbs is extended with each additional orb installation, a line of orbs (hereinafter referred to as a String-of-Pearls) may emerge and become sufficiently large to begin serving the larger hurricane and planetary temperature regulation purposes. For the larger implementations the platforms may become totally self-sufficient providing energy for residential, aquacultural, agricultural, industrial, commercial, medical, recreational and educational needs.

Therefore, in addition to providing fluid property profile regulation, each ORB Fluid Property Regulator installation may become a multi-purpose energy and food production facility, and serve many other self-sustainment purposes for a number of years. Each orb envelope, at the end of its life cycle, may then be filled with biological material and lowered into a deep ocean canyon for long-term carbon storage purposes perhaps with periodic netting overlays through time. Each new orb envelope, itself a product of carbon fixation if made of carbon based fabric, will be installed to serve as a “replacement unit” for the recently retired orb at the end of its useful surface life.

The self-propelled embodiments of the multi-layer Fluid Property Regulator invention, may regulate temperature and nutrient profiles, such as in the Sargasso Sea in the Atlantic Ocean, and thereby lower the average atmospheric temperature so that less planetary ice is melted and more precipitation falls in the form of snow on planetary ice sheets, such as glaciers in Greenland. If the historically rapid and recent melting and accelerated flow of the glaciers in Greenland toward the ocean is kept under control, using the Fluid Property Regulator concept, there will be less intrusion of cold fresh water into the Atlantic Ocean. Then, the Gulf Stream may no longer be halted due to such low-density fresh surface-water incursions as has interrupted the Gulf Stream in recent years due to global warming. Finally, as a proper amount of ice sheet reflectivity is restored, given re-growth of glacier size due to the Fluid Property Regulator's effect on lowering atmospheric temperatures, then the ongoing excess solar heating of the planetary surface, which has been occurring because of diminishing ice-sheet size, will be reversed-and hence long-term planetary temperature regulation can be maintained in spite of the higher levels of greenhouse gasses that have reportedly been heating the atmosphere. Furthermore, carbon that is fixed into marine plant material and stored after harvesting to help reduce greenhouse gasses from present levels, according to embodiments of this Fluid Property Regulator invention, may eventually be used for energy consumption without adversely affecting worldwide temperatures once planetary ice sheet reflectivity is sufficiently restored. In the very long term, a slight intentional overshoot in the creation of ice-sheets, and hence increased reflectivity, will allow re-stratification of the oceans and the subsequent retirement of many Fluid Property Regulator deployments once temperatures fall below hurricane and global warming levels of concern. This will create a truly sustainable climate control balance while reserving the option of reintroducing hurricanes and sea level rise, by controlling to a set-point for renewed global warming, if such were ever to be desired.

This Fluid Property Regulator technology can be used for purposes such as ocean engineering applications involving fishing, aquaculture, carbon fixation, ocean industry, ocean energy, ocean shipping/commerce, military sea basing and ocean recreation as well as, ultimately, for hurricane dissipation, and eventually planetary climate regulation. This invention thus introduces a technology that might play a role in potentially facilitating the alleviation of several world problems including ongoing world hunger, industrial pollution near populations, fossil fuel dependence, seaport congestion, hurricane susceptibility, undesirable atmospheric gas retention, glacial melting, sea level rise, Gulf Stream stoppages and global warming.

### BRIEF DESCRIPTION OF THE DRAWINGS

In the drawings,

FIG. 1 is a perspective view of a Fluid Property Regulator installation showing orbs arranged as a “string of pearls” to produce material property regulation for multiple purposes according to a preferred embodiment of the present invention;

FIG. 2 shows measured velocities of the localized Inner Loop Current within the Gulf of Mexico where hurricanes are energized (with measured velocity magnitudes of warm surface water represented by arrow lengths). Orb bodies in a “string of pearls” arrangement will dissipate hurricanes according to a preferred embodiment of the present invention;

FIG. 3 is a side view of a single orb positioned in a current that is flowing from left to right (i.e. the view is from East, looking West, for the Yucatan Strait example of FIGS. 1 and 2) according to a preferred embodiment of the present invention;

FIG. 4 is an orb arrangement for which additional deep-water for property regulation is achieved by embedding Carnot cycle tubing into the orbs and buoyancy collar as well as a wave-pump dispersion network according to a preferred embodiment of the present invention;

FIG. 5 is an elevation view of a three-orb conglomerate arrangement, as seen from upstream, where one smaller orb and a water turbine are nestled into the gaps between two larger orbs according to a preferred embodiment of the present invention;

FIG. 6 is a top view of a three-orb conglomerate arrangement where winches adjust orb location in a flow stream according to a preferred embodiment of the present invention;

FIG. 7 is an orb arrangement showing a network of supplemental dispersion pipes with marine plants growing on a grid structure between dispersion pipes according to a preferred embodiment of the present invention;

FIG. 8 shows an in-line waterwheel pump having both external blades and internal blades that are connected concentrically to each other through a water-seal arrangement for pushing supplemental deep water up through a pipe according to a preferred embodiment of the present invention;

FIG. 9 shows how discharging surface water downward into a pump housing will force pump blades to turn and thus drive cold deep water up a deep-water pipe, regardless of current flow rate, according to a preferred embodiment of the present invention;

FIG. 10 shows a fixed toroidal discharge tip that concentrates Venturi suction effects to help draw deep water up a pipe according to a preferred embodiment of the present invention;

FIG. 11 shows an apparatus to avoid pipe wall collapse given flow induced by a pressure differential between water inside and outside a large pipe according to a preferred embodiment of the present invention;

FIG. 12 shows a horizontal water wheel pump arrangement that can be coupled with a Carnot cycle pump arrangement to drive deep-water up a large pipe according to a preferred embodiment of the present invention;

FIG. 13 shows an automated orb-depth regulation subsystem to adjust lift and thereby accommodate changes in current speed according to a preferred embodiment of the present invention.

FIG. 14 illustrates a device for lowering an orb below the wave zone during heavy storms, or into a canyon at the end of the orb's life cycle, according to a preferred embodiment of the present invention;

FIG. 15 shows the use of a cylinder, as an alternative to a spherical orb as an acting body, according to a preferred embodiment of the present invention;

FIG. 16 shows the use of a drape kite, as an alternative to using a spherical orb as an acting body, according to a preferred embodiment of the present invention;

FIG. 17 shows the use of a drag-chute, as an alternative to using a spherical orb as an acting body, according to a preferred embodiment of the present invention;

FIG. 18 shows the use of a hemidome, as an alternative to using a spherical orb as an acting body, according to a preferred embodiment of the present invention;

FIG. 19 shows the use of a trough, as an alternative to using a spherical orb as an acting body, according to a preferred embodiment of the present invention.

FIG. 20, shows a train of orbs that progressively lift deep water to higher levels, according to a preferred embodiment of the present invention.

FIG. 21, shows the use of orbs in a tidal current, such as in the Gulf of California, where each incoming tide causes deep water to lift toward the surface and each outgoing tide allows surface water to flow freely out to sea, according to a preferred embodiment of the present invention.

FIG. 22 shows a canal lock in the orb buoyancy collar that allows entry by a vessel through weir gates, according to a preferred embodiment of the present invention;

FIG. 23 shows an energy self-sufficient application for regulating nutrient content for marine food and energy production in an island cove or atoll, according to a preferred embodiment of the present invention;

FIG. 24 shows an application for regulating the temperature of the earth's atmosphere by first regulating the temperature of the ocean surface with which the atmosphere is in contact, according to a preferred embodiment of the present invention.

### DETAILED DESCRIPTION OF PREFERRED EMBODIMENTS

The Fluid Property Regulator methods, and system embodiments of this invention generally have at least one moored or self-propelled body of spherical, cylindrical or other shape (e.g. an orb) that causes material transfer and fluid flow to regulate material properties when such an orb is either moved in a fluid or held stationary in a flow stream. Transfer of portions of the material surrounding the system may alter the material property profiles of the material (e.g. fluid) as that material proceeds past the system in a flow field. Many features of the methods, system and apparatus, beyond those described below, will be apparent to skilled artisans. The following descriptions generally progress from one feature of emphasis to another feature of emphasis with a wide variety of additional embodiments being possible based on combinations of the features that are highlighted among the various figures and descriptions.

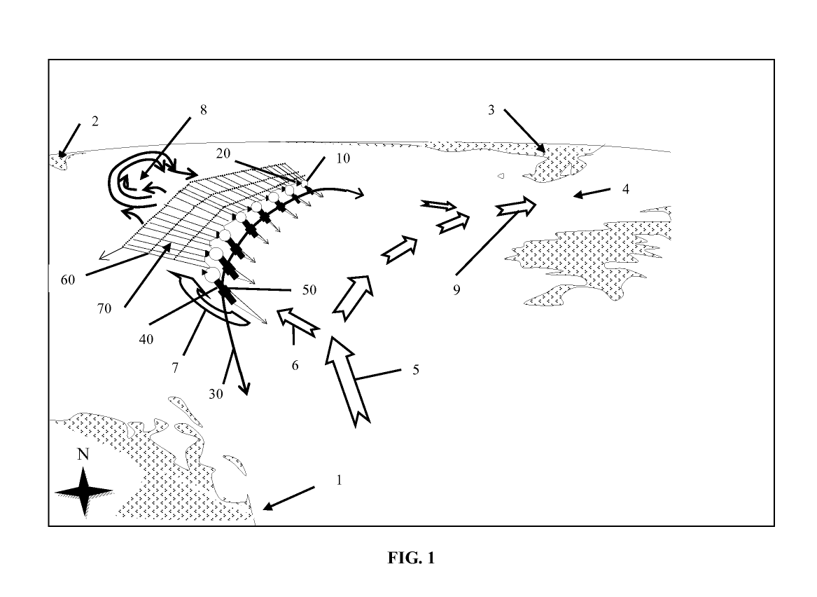

Referring now to FIG. 1 there is shown an example instantiation of a Fluid Property Regulator, using the technology of this invention, for self-sufficient ocean temperature and nutrient regulation—at a site location suitable for hurricane dissipation. For this hybrid energy self-sufficient embodiment, suitable for use at for a location approximately 50 miles northeast of the Yucatan Peninsula 1, for example, the prospect of hurricane dissipation due to surface water property regulation will be achieved for the Gulf Coast Region of the United States between Texas 2, and Florida 3, in a region that is Northwest of the channel where the Gulf Stream current flows through the Florida Strait 4. For this implementation, there is a point where the Yucatan Current 5 forms a branch current 6, such that a layer of cold deep water 7 can be caused to flow upward, using the methods and systems of this Fluid Property Regulator invention, to cause the average surface water temperature in the Inner Loop Current 8 to be regulated. By way of this invention, the Inner Loop surface temperature may be maintained near the same average temperature as the rest of the surface water of the Gulf of Mexico so that it is not hot but does not submerge below nearby waters of the Gulf of Mexico. To the extent that the average surface water temperature of the Inner Loop diminishes (e.g. from 90 degrees Fahrenheit toward 80 degrees Fahrenheit) in the top 200 feet of water, hurricane emergence (or sustainment) will be curtailed. The methods of this invention comprise using particular high Reynolds number (e.g. trans-critical) fluid flow characteristics associated with the relationship between fluid velocity, viscosity and body size (parameters of the Reynolds Number) to cause material property regulation in the downstream far-field region relative to the body in a current. The system associated with the methods of this invention may include an archipelago of at least one body 10 that may be spherical, cylindrical or another barrier shape. The body may be made of steel, concrete, or other material such as fabric and may have a very slight internal pressure head of water that is sufficient for the body to maintain shape without significant structural reinforcement. The body does not displace a large amount of water with air, as must a structurally demanding ship, so the body may be flexible and made of fabric, such as PolyVinylChloride (PVC), while remaining essentially unaffected by surface waves due to its nearly neutral net buoyancy. As a result of flow around the body, deep cold water is raised in the turbulence of the far-field regulation area downstream of the orbs. One embodiment of this invention includes multiple features including a Carnot Cycle for pumping supplemental cold nutrient-rich deep water through at least one pipe 40 for dispersion, and may also make use of at least one secondary dispersion pipe 60 to distribute nutrients and/or trace element fertilizers to a grid area 70 in which to grow marine plant material for food and energy production. The orb system is arranged so that fluid property regulation results from flow around the orbs, as well as around any barriers in the dispersion area, with energy self-sufficiency and electricity generation from supplemental energy sources as desired. A combination of propulsion subsystems 20 and/or mooring subsystems 30 cause relative flow between the orb bodies and the stratified ocean layers. As cold water is raised it may be used as condenser water for the Carnot cycle (i.e. an energy cycle based on ammonia steam or other low boiling-point working fluid) to turn a turbine shaft for purposes such as the pumping of more deep water, or for turning a screw for propulsion and/or to generate electricity as desired. To overcome friction loss in the deep-water pipe, at least one in-line pumping station 50 may be installed that may use deep water currents for additional pumping power. Marine plants (e.g. Macrocystus mexicanus or pyrifera, known as giant kelp, or other marine plants such as algae) may be grown on grid substrates 70 or in containers to make use of the nutrient rich waters lifted into the fluid property regulation (dispersion) area. The marine farm may, in turn, provide an improved environment for fishing while providing additional resistance to the flow of warm surface-water and thus cause the raising of additional deep water, due to the additional marine plant barrier, for enhanced material property regulation. As a result of the several system features, fluid property regulation improves hurricane regulation through a multiplier effect. CO₂ fixation may also be achieved by storing kelp or other marine plant material inside the orbs for long-term storage such as after each marine farm harvest. Alternatively, the marine plant material can be used as a renewable source of energy, food and other products.

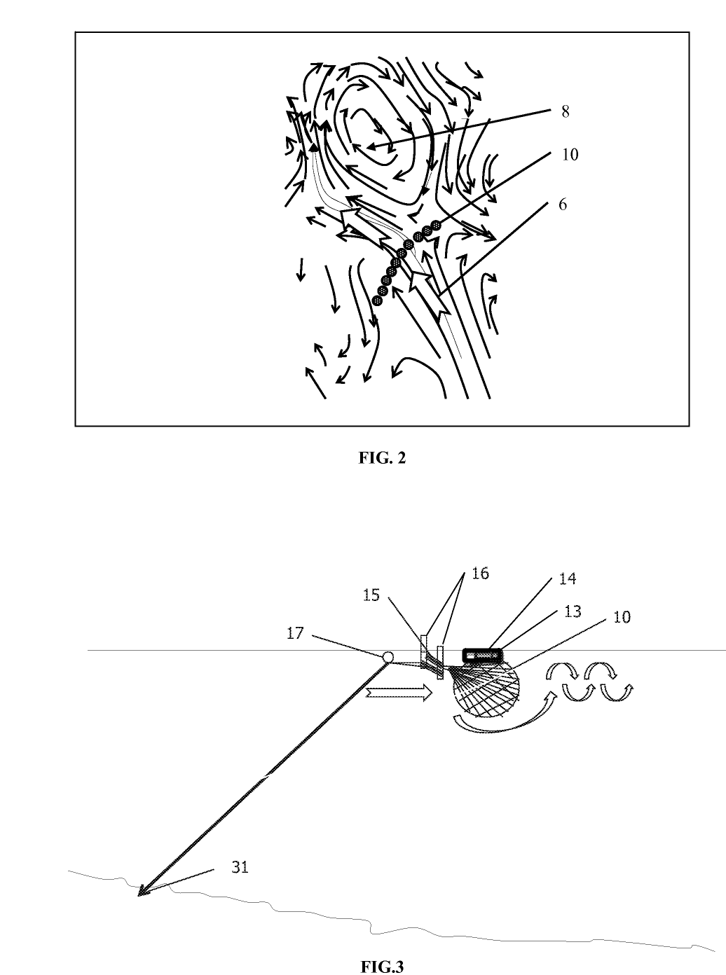

Referring now to FIG. 2 there is shown a set of at least one orb 10 superimposed on actual data demarcating the overheated Inner Loop Eddy Current 8 where nearly all Gulf Coast land-fall hurricanes are formed or energized in the Gulf of Mexico. (Flow velocity is indicated by the length and direction of contour arrows where long arrows have highest velocity). The fluid-filled orbs redirect current flow 6 causing the lifting and combining of different strata of ocean water into the down-current surface region. As in FIG. 1, the subsystems of the orb implementation combine to raise cold deep water, from beneath the orbs and from supplemental sources such as from additional deep water introduced through deep-water pipes, to feed into the Fluid Property Regulator combining cold deep water with any warm surface water in the downstream far-field of the flow stream and thereby causing properties such as temperature to be regulated to a desired set-point temperature in the top region of the ocean. The average surface temperature, due to regulation, will be lower compared to the temperature profile such a region would otherwise have in the top 200 feet. While each orb may be economically viable as an energy platform by itself, the combination of multiple orbs may result in surface temperatures being low enough, such as below 80 degrees Fahrenheit in the top 200 feet, that hurricane formation and sustainment is curtailed.

Referring now to FIG. 3 there is shown a single orb positioned in a current that is flowing from left to right (i.e. the view is from East, looking West, for the Yucatan Strait embodiment of FIGS. 1 and 2). Each orb body may be self propelled (not yet shown in this initial figure) or moored using at least one anchor line 31 so that relative motion is achieved between the orb body and the surrounding material in a flow field. A buoyancy collar 14 and/or a hydrofoil 15 may contribute lift so that the vertical force component of the tension in the mooring line, due to any current speed increases, does not submerge the orb below the desired depth. A canal lock 13 allows vessels to enter the buoyancy collar's harbor-at-sea and may allow waves and current flow to enter for purposes such as to maintain slightly elevated water pressure inside the orb or for energy generation purposes.

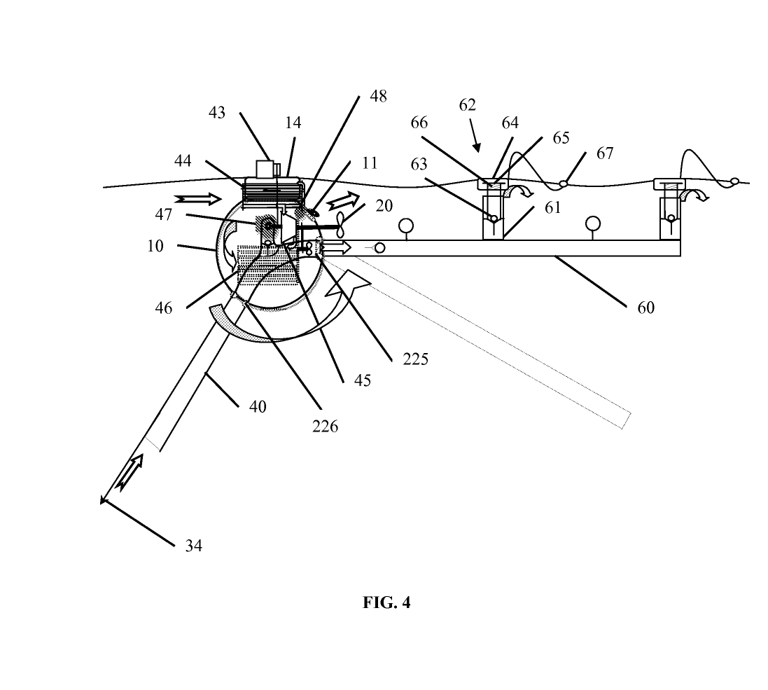

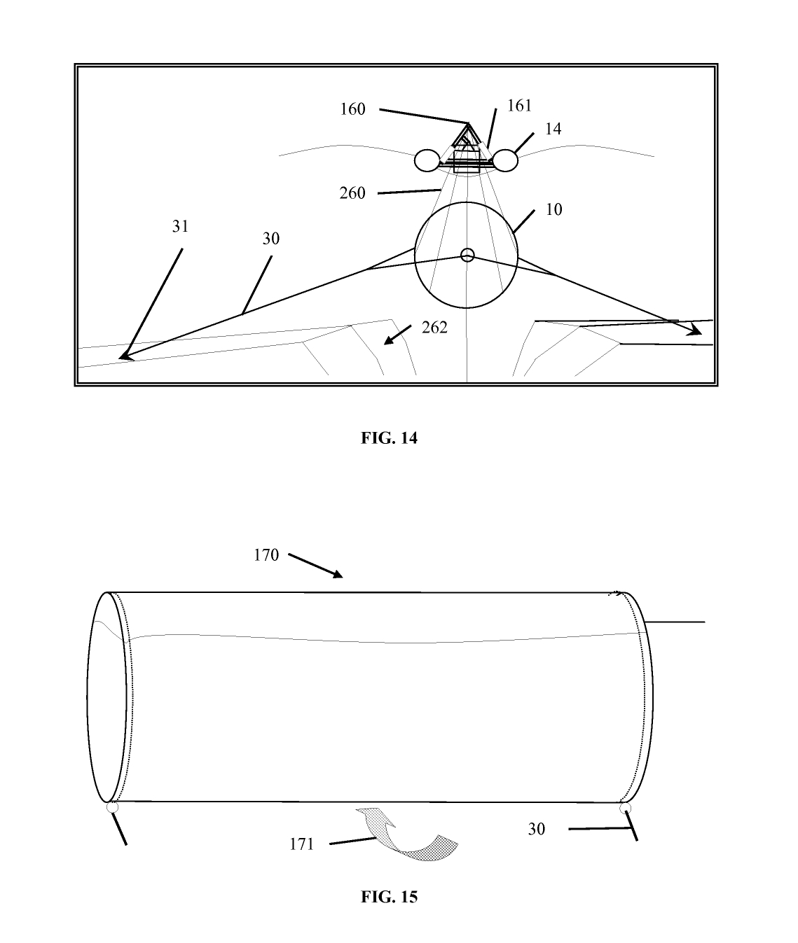

Referring now to FIG. 4 there is shown an orb arrangement for which warm surface water is deflected under and around at least one orb 10 to cause deep-water uplifting that contributes to regulation of water properties in the orb's downstream far-field. Fluid property regulation is also the result of a supplementary Carnot cycle that feeds additional deep water into the flow field of the Fluid Property Regulator orb. As warm surface water passes the buoyancy collar 14, this warm water loses some of its heat by heat exchange in the process of boiling a working fluid with low boiling point such as ammonia or light oil inside specially situated tubing 44, such as titanium tubing, thus further altering surface water properties to a lower temperature. The boiled working fluid (ammonia, or other low boiling-point working fluid), then passes through an ammonia steam turbine 45 which rotates a shaft that may drive a propulsion system 20 as well as a pump 47 to raise additional cold deep water through a pipe 40 for dispersion and property regulation. The shaft of the steam turbine may also be connected to drive an electric generator 43 with electricity used on-site for supplemental cold water feed to the Fluid Property Regulator orb, for energy self-sustainment and/or for sending power to nearby energy consumers such as via a mooring line that carries an electric cable 34 to deliver electricity to a power grid ashore. The cold deep water may be pumped into the orb to circulate within the orb to cool at least one specially situated condenser coil 46 and thus convert the ammonia steam (or other working fluid steam) back to liquid form. By suspending the heat exchanger coils underwater, the buoyancy required to hold up these components is significantly smaller than if water was pumped into heat exchangers in air filled compartments as one might conventionally expect the heat exchangers to be housed. The liquid working fluid, once condensed, is pumped back to the warm water heat exchanger tubing (on the buoyancy skirt) to complete the Carnot cycle while the portion of cold deep water used in the heat exchangers, after being raised and circulated through the condenser coils, is discharged through a pressure regulated flapper valve 11 into the Fluid Property Regulator orb dispersion area for further fluid property regulation. By properly setting the pressure of the flapper valve, sufficient pressure head exists inside the orb such that the orb maintains its shape in spite of current forces. A portion of the deep water raised through the pipe, (a majority of the pipe flow at start-up), is dispersed through at least one secondary dispersion pipe 60 to at least one dispersion port 61 that is downstream in the far field of the turbulent flow. Dispersion may be assisted by at least one wave pump 62 which utilizes concentric tubing and a one-way valve 63 to pull water out of the dispersion pipe with each rising of a float 64 that rides the waves. The ball (or flapper) of the one-way valve unseats when the float falls in the waves while water flows through the valve. Cold nutrient-rich water that is thus discharged through the dispersion ports, plus any added fertilizer elements such as trace metals may stimulate marine plant growth. Nutrient levels in the deep water depend on the depth of uptake from the bottom of the pipe as well as the location of the oxygen-maximum zone in the water column, so this may factor into the length of the deep water pipe that designers select for providing the additional water to further alter the material properties of the nearby ocean surface water in terms of temperature and nutrient profiles as well as other properties within engineering and environmental constraints. Several features of the system protect against storm waves. As wave activity exceeds a pre-set threshold, for example, the stroke of the wave pump will reach its maximum travel limit. Then further pumping action will cause a second piston 65 with a stiffer spring 66 to begin compressing air into a tank while allowing water to fill the void such that the float assembly becomes negatively buoyant. Thus in high wave conditions, such as the hours preceding an actual hurricane, the grid structure will lose buoyancy and descend to below the wave effected zone, swiveling about gimbal 225 and assuming a position as indicated by the dotted configuration in the figure. A thin snorkel tube 67 continues to float at the surface. The wave pumps will not resurface until wave action is sufficiently diminished. At that time, much of the compressed air will flow past the inactive compressor piston and back into the chamber that was flooded and again provide buoyancy that returns the dispersion pipes and grid lines to normal operating depth. The snorkel tube may also allow manual reestablishment of buoyancy as a back-up to the automated buoyancy control system. A device or mechanism for lowering the entire orb below the wave zone prior to a storm that will exceed design specifications (such as a 2000 year storm, perhaps) is described in the section below regarding FIG. 14. Traditional winches may also be deployed to reef the dispersion pipes and gridlines down to the submerged downstream mooring cables of the system prior to known oncoming storm conditions. If the system is reconfigured for self propulsion, as in the case of deploying multiple orbs to ply the Sargasso Sea in order to achieve global temperature regulation, there may be no mooring system and the deep water pipe may be weighted and allowed to swivel slightly about its gimbal 226 to accommodate the forces of relative fluid motion on the lower reaches of the pipe.

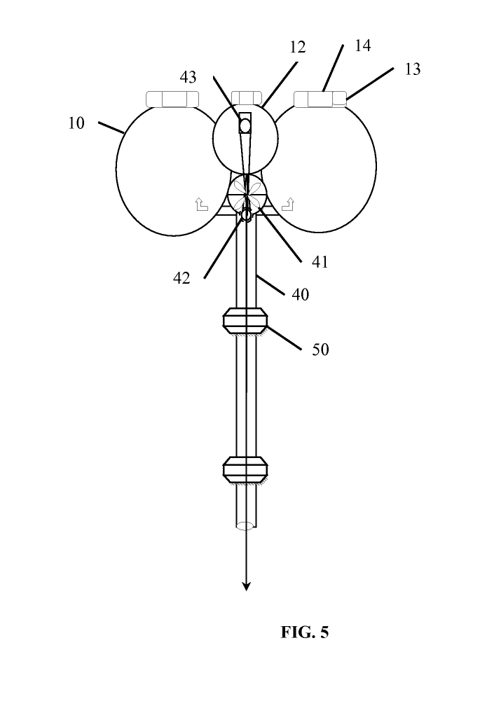

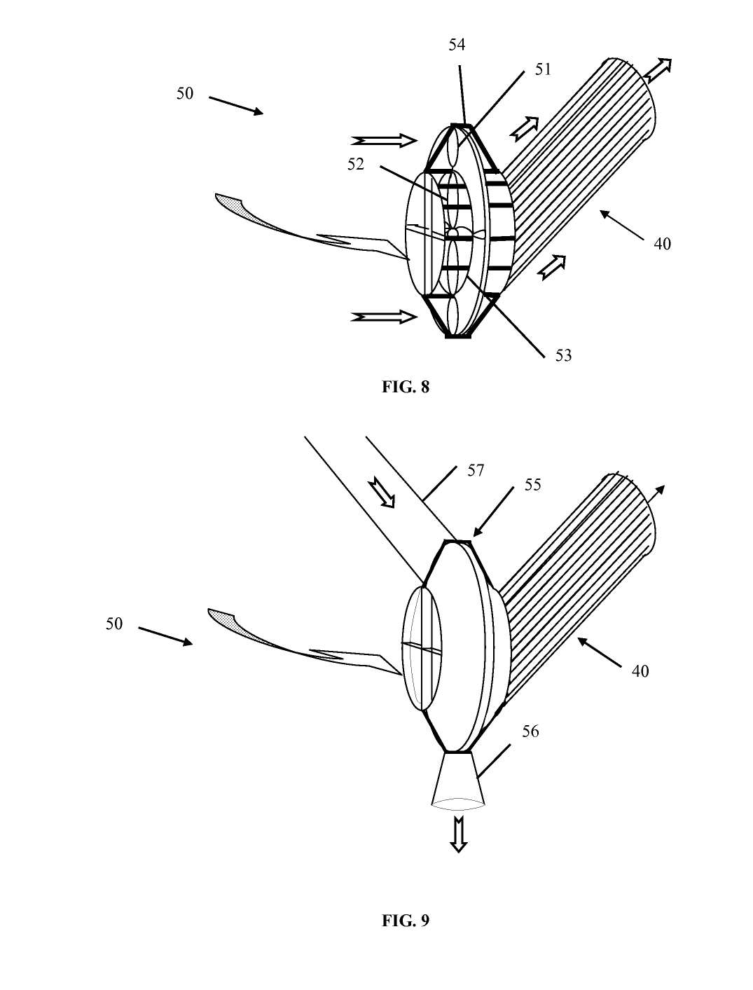

Referring now to FIG. 5 there is shown a three-orb conglomerate arrangement, in elevation as seen from upstream, where one smaller orb 12 is nestled into the upper gap between two larger orbs 10. To draw water up through a pipe 40 (i.e. to raise supplemental deep water) a water-current turbine 41 may be installed to drive a water pump 42 and thus increase fluid property regulation. To generate supplemental electricity for self-sustainment at sea, a generator 43 may be installed in addition to (or in place of) the water pump and pipe. In the case where the deep water pipe is installed, at least one in-line pumping station 50 (shown and described further in FIG. 8) may help overcome friction losses and provide some internal pipe pressure to guard against vacuum cavitations and pipe wall collapse.

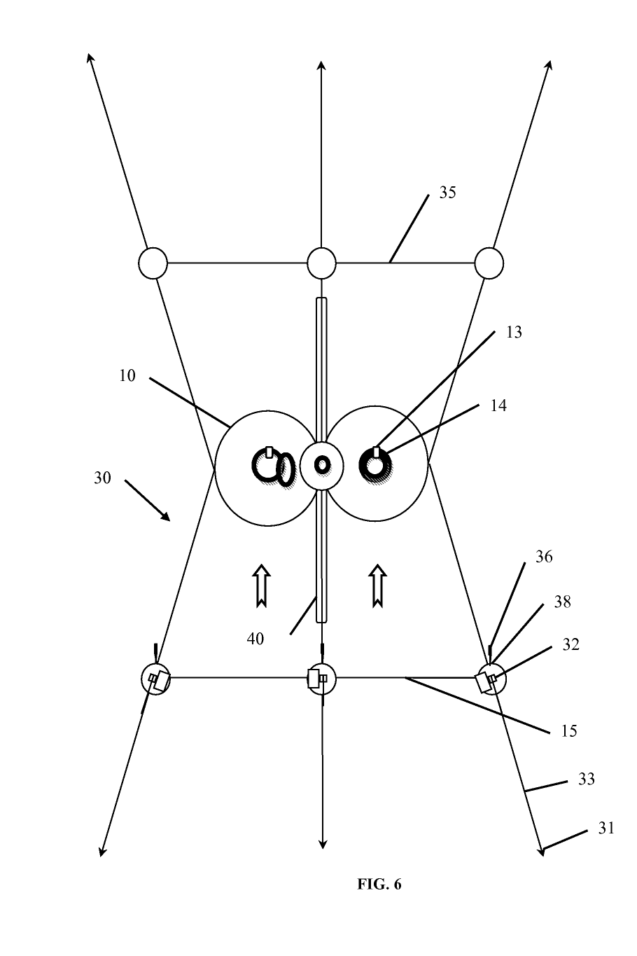

Referring now to FIG. 6 there is shown a top view of a three-orb arrangement similar to that of FIG. 5. (As in FIG. 5 one small orb continues to be nestled into the upper gap between two larger orbs in this multi-orb conglomeration). For moored arrangements of the present invention, a Tiara mooring 30 may include at least one buoy 38, and on such buoys (or on the orbs themselves) may be installed at least one winch 32 to position the system in a desired location in a flow stream by changing the length of at least one mooring cable 33 to at least one anchor 31 embedded in an outside reference point. One or more Computer Data Acquisition Arrays of sensors 35 including data loggers, computers and controllers may monitor and control the system to regulate water property profiles and other parameters by controlling cable length and other factors, as a function of flow stream temperature, nutrient content, position, velocity and other parameters, to optimize system operation in the region of interest for a particular application. At least one rudder 36, on a system member such as a buoy, or at least one other deflecting kite-like vane (e.g. hydrofoil) 15, located between mooring buoys or along the mooring lines, may be controlled to steer the orbs and to damp out any fluid flow vibration effects while spreading the orbs apart against current forces that could otherwise pull them together.

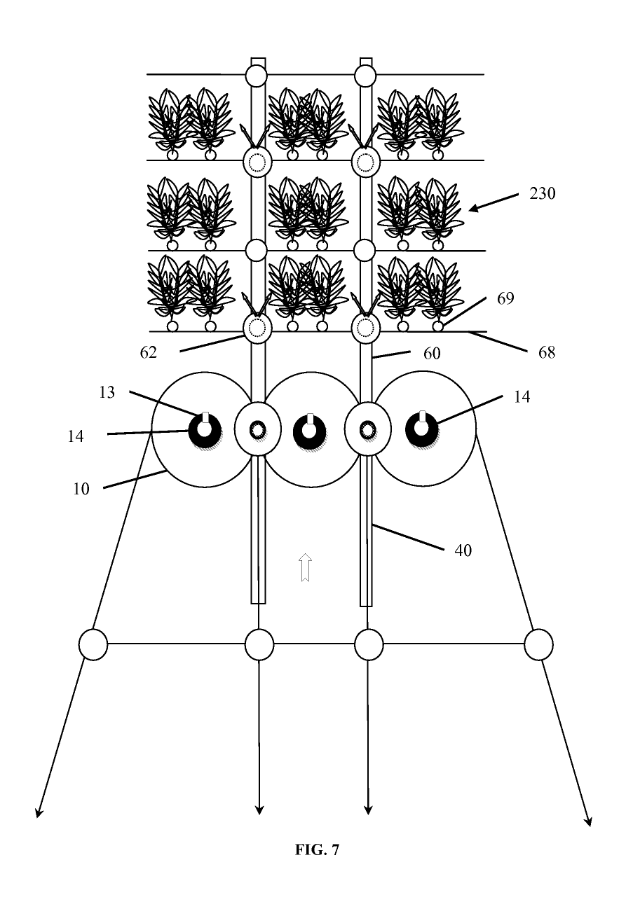

Referring now to FIG. 7 there is shown a multi-orb arrangement for which water is deflected around at least one orb 10, perhaps with the raising of supplemental deep water through one or more pipes to feed the Fluid Property Regulator orb system with additional cold nutrient rich-water—e.g. for a Carnot cycle and marine plant farm. In the downstream far-field of the flow stream (top of figure) is shown a network of at least one dispersion pipe 60 from which raised water is drawn by wave pumps 62 to distribute additional cold nutrient-rich water to further alter temperature profiles, nutrient profiles and other properties. The wave pumps provide enough pumping power to keep up with the rising pressure head due to fluid flow friction losses inside the tubes of the dispersion network. Giant Kelp (e.g. Macrocystus Pyrifera or Mexicanus) 230 is grown in the nutrient-rich region downstream of the orbs. Kelp plants may be attached to small submerged buoys 69 located at suitable intervals on grid lines 68 that may be made of polypropylene rope, and the canopies of these plants may be periodically harvested as a supply of marine plants for food and energy. Macrocystus can grow up to two feet per day and then grow back (coppice) after harvesting. Harvested marine plant material, with high carbon content, may be deposited for long-term storage into one or more orbs through an opening 13 such as a canal lock in the buoyancy collar 14. Biological energy conversion methods such as anaerobic digestion may be introduced to convert marine plant material in the orb body to an energy product. Fermentation to ethanol, pyrolysis and Hydrogen production are alternatives. The dispersion network also provides a platform for supporting containment regions near the orb body to allow fishing and aquaculture farming in the nutrient-rich property-regulated fluid region nearby. The kelp farm also provides surface-current resistance in the overall flow field and thereby increases the raising of yet additional deep water in the downstream far-field, beyond the system as a whole, for purposes such as increased hurricane regulation. As wave activity exceeds a pre-set threshold, wave pumping action as described in FIG. 6 is converted into compression of the air below a diaphragm such that water enters the float above the diaphragm and buoyancy is diminished causing the grid structure to submerge below the wave-affected zone until wave action is sufficiently diminished. Then the dispersion/marine plant grid network rises back to its normal near-surface location. With multiple orbs, some orbs could be dedicated to storing and dispersing additional fertilizer elements including ferrous, cupric or other trace metals, as needed, while other obs could be dedicated to storing energy products ranging from ethanol, methane, and hydrogen to auto, truck, jet, and ship fuel produced on site or shipped from elsewhere. Some orbs could store fresh water from on-site desalinization and others could store items for industrial inventory handling and commercial shipping purposes.

Referring now to FIG. 8, there is shown an external current driving a waterwheel 50 having both external blades 51 and internal blades 52 that are connected concentrically to each other through a water-seal arrangement 53. The external housing 54 is a cage that allows the ocean current to drive the external blades while flowing through the cage. As water current flows past the external blades, the internal blades are forced to rotate, by direct drive or planetary gear arrangement, providing internal flow and added pressure to overcome friction losses for deep water flowing up through the deep-water pipe. A planetary gear arrangement may drive an Archemedian screw at higher RPM if desired. One or more specially designed concentric water wheels is incorporated at one or more points along the pipe to boost flowrate inside the large pipe while avoiding vacuum cavitations and pipe collapse.

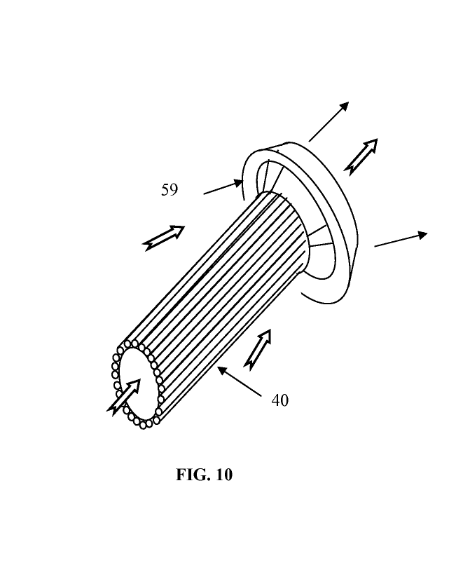

Referring now to FIG. 9, there is shown a combination of at least one deep-water pipe 40 and at least one submergence pipe 57 such that submerged warm water discharges into an enclosed blade housing 55 that contains the outer blades so that submergence discharge water forces the outer pump blades to turn and thus drive the inside blades to pump cold water up the deep-water pipe (i.e. regardless of whether there is deep current flow rate). Warm water is discharged at a depth through outlet 56.

Referring now to FIG. 10, there is shown a toroidal discharge tip 59 that concentrates Venturi suction effects to help draw water up the pipe 40. The cap angle at the discharge tip is controlled to achieve desired discharge position in a flow field. This tip may be installed in a hybrid manor between orbs, such as in the conglomerate configuration of FIG. 5, where flow velocity is greatest. When concentric pump 50 of FIG. 8 is located at the discharge end of the deep-water pipe and also pumps water, the addition of this discharge tip will achieve an amplified Venturi and current-flow pumping effect.

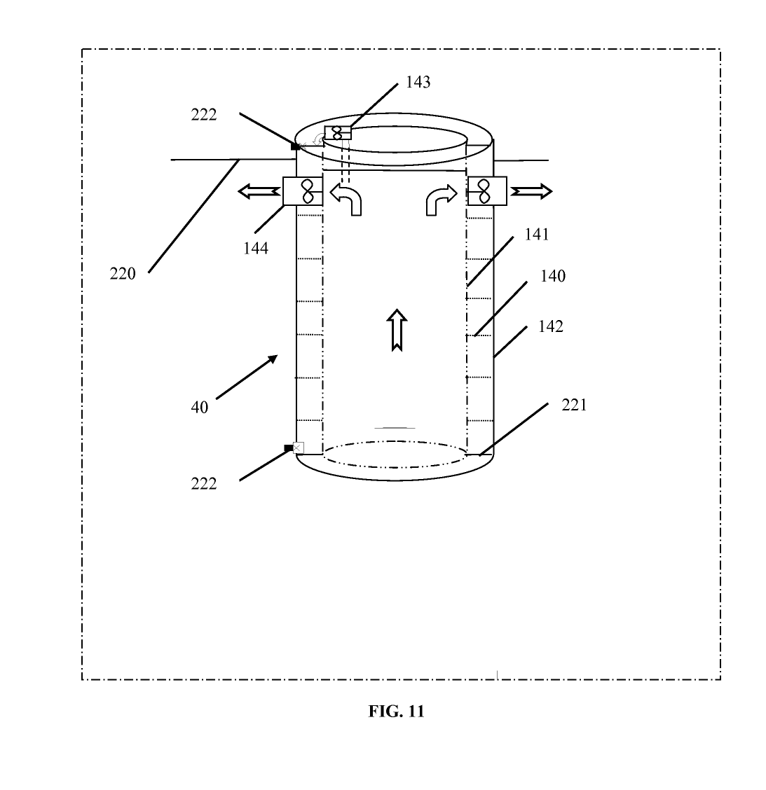

Referring now to FIG. 11, there is shown an additional apparatus to avoid pipe wall collapse in pipe 40—for example in the case where only a few in-line pumping stations (or none) are used. A water-wall is created between an inner wall 141 and an outer wall 142 of pipe 40. These two relatively thin shells contain water at elevated pressure to increase pipe stiffness. A small pump 143, on top, adds water into the space between the concentric shells (which protrude above the outside water level) to provide the pressure head needed for enhanced stiffness. This stiff water-wall is created such that when water is pumped out of the pipe via at least one discharge pump 144, water fills back in through the bottom of the pipe such that the pipe is continuously replenished with raised deep water. The water-walled pipe does not collapse as would the relatively thin walls were they to have no water-wall. The same stiffness is thus achieved as for a much thicker walled pipe of ordinary pipe design. Reefing ties 145 hold the inside wall to the outside wall while water is being discharged to the surrounding ocean causing reduced pressure head inside the inner wall of the deep-water pipe. The base of the water wall 221 is sealed to connect the inside shell to outside shell with a relief valve 222 at the top to insure that water-wall pressure is properly regulated to a safe level between the two walls. The center section of the pipe, which is the conduit through which cold deep water flows, is open at the bottom.

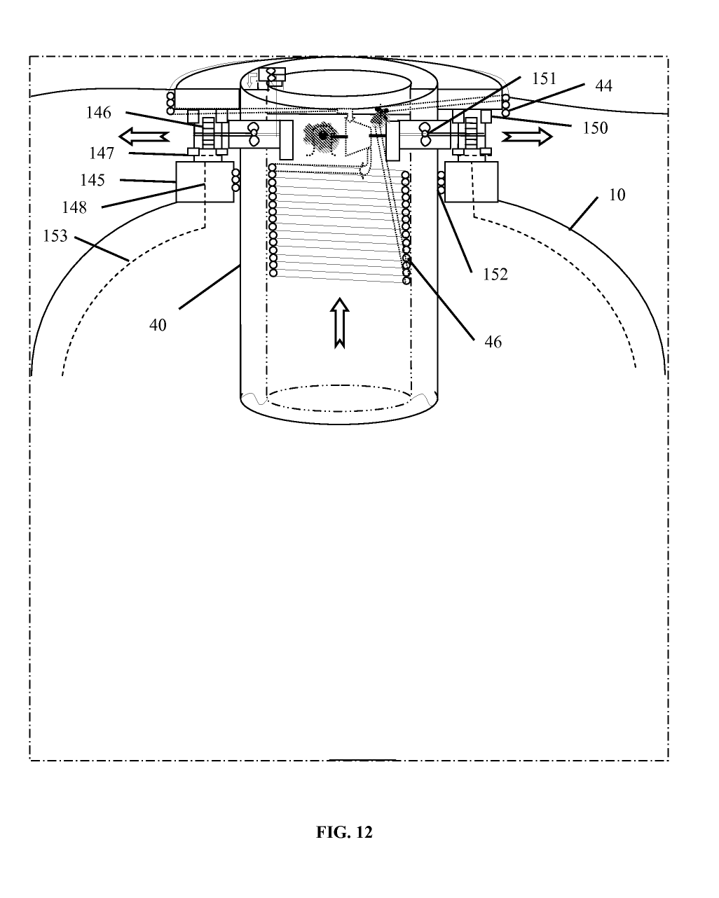

Referring now to FIG. 12, there is shown added to pipe 40 a horizontal water wheel 145 to drive at least one discharge pump 144. The rack gear 147 of the waterwheel may be embedded in a buoyancy collar so that it drives at least one pump pinion gear 146 from underneath, while the horizontal waterwheel is submerged below the wave crests. The waterwheel is of larger diameter than the pipe and drives at least one pinion gear connected to at least one pump shaft of the large pump 144 as the circular rack gear of the water wheel 147 rotates around the pipe under the influence of the surface current on the waterwheel pockets 148 of the horizontal water wheel. Supporting cables wrap over ram tensioning devices 150 that allows the buoyancy collar to lift with wave motion while the pipe remains essentially stationary. The pump shaft passes through a universal joint 151 so that the gearing remains engaged with the rack despite wave motions. Additional pockets 153 may be further embedded in the orb itself such that the entire orb rotates as a horizontal water wheel with a thruster bearing mechanism 152 that allows rotational motion between the pipe/pumps and the rest of the orb assembly. The Carnot cycle described for FIG. 4 may or may not be included with current power to provide a hybrid device of providing supplemental deep water pumping, propulsion and other uses.

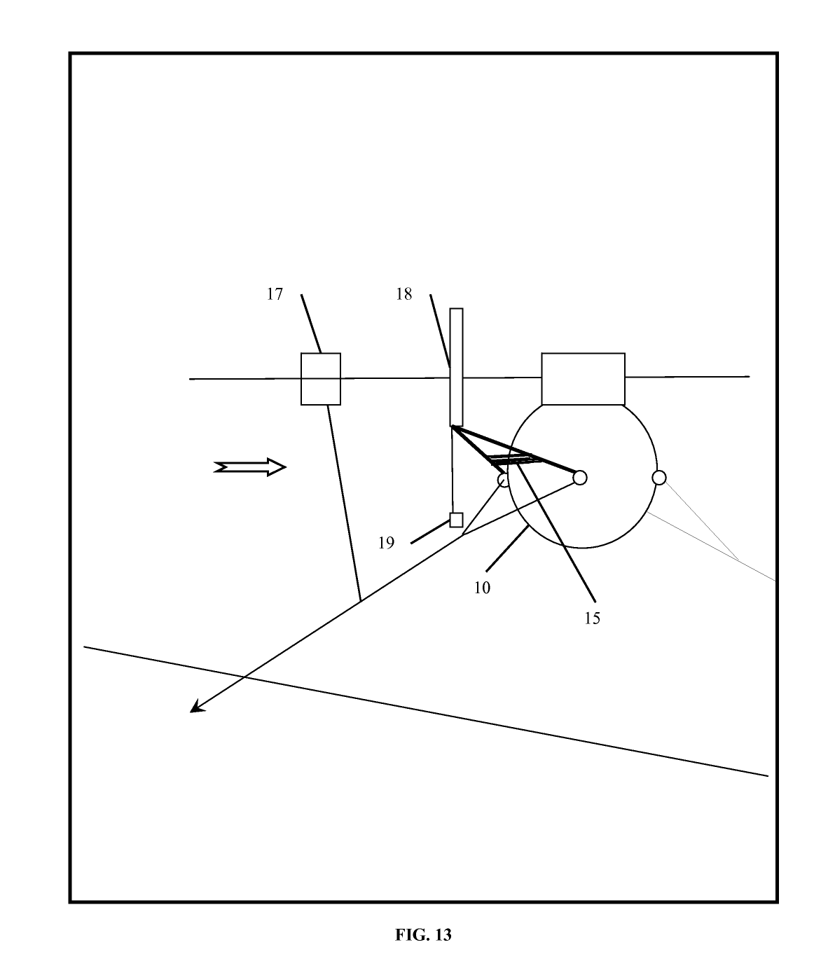

Referring now to FIG. 13, there is shown a device to regulate the depth of the orb 10 as buoyancy fluctuates and current velocity increases. Should the orb begin to ride lower in the water due to marine growth, for example, the leading edge of the hydrofoil 15 will necessarily assume a higher angle of attack due to there being a fixed distance between the leading edge of the hydrofoil and the base of a Set-Point float 18 to which it is attached. As the orb loses buoyancy and the leading edge therefore rises (while the trailing edge lowers due to rotation about a pivot point) the resulting lift provided by the hydrofoil in a current will increase. This will provide additional lift to the orb, in a flow stream, to counter the greater current speed or negative buoyancy due to marine growth or other cause. If the orb rises in a slow current, by contrast, the counter-weight 19 pulls the leading edge downward causing the orb to dive to the set-point depth. By making the Set-Point float tall, the float will not be susceptible to wave action. By adjusting the amount of ballast in the Set-Point float, the initial angle of attack will be adjusted.

Referring now to FIG. 14, there is shown a set of at least one lowering line 260 providing a device to lower an orb beneath a derrick 160 mounted atop a buoyancy collar 14 with at least one ram tensioner 161 that retracts as required to accommodate wave motion, but which extends, by springing back, to insure that slack is never created in the support cables as the excess cable tension subsides. Shortly before a major storm, for example, these lowering lines will lower the orb below the wave zone. Eventually, at the end of the orb's useful surface life cycle, the orb will be filled with marine plant material (i.e. material having high carbon content) and may be lowered into a canyon 262 for semi-permanent storage. Since many such orbs may be lowered into the canyon over time, the resulting carbon reserve will not only serve to remove carbon from the atmosphere in the near term, but will become a potential hydrocarbon source in the future (i.e. after ocean resource balancing is ultimately achieved for the steady state). The buoyancy collar 14 remains at the surface through a storm and is re-rigged afterward with a new orb. A new orb is keel-hauled into place after an old orb is deposited for long-term storage. The orb may be secured by a mooring system 30 including at least one anchor 31.

Referring now to FIG. 15, there is shown a cylinder 170 that could be used as a body of the system in another alternate embodiment. The body may be secured by a mooring 30. Current flow 171 flows under the cylindrical Body. The system, and peripherals, may be otherwise similar to embodiments described in regard to FIGS. 1-14.

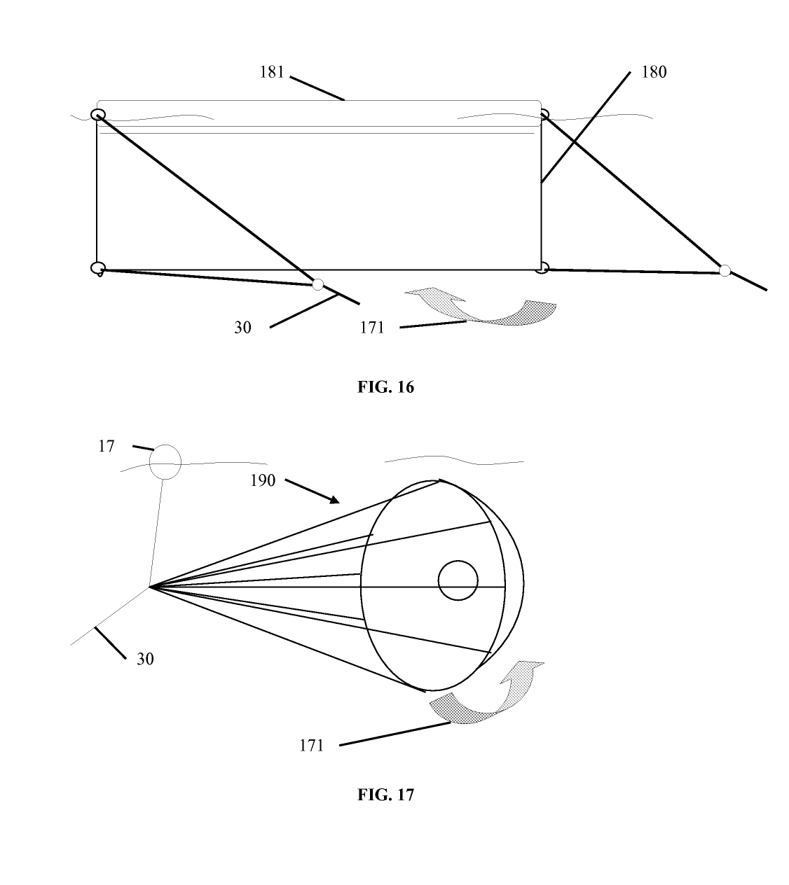

Referring now to FIG. 16, there is shown a draped body 180 that could be used as a body of the system in another alternate embodiment. The body may be secured by a mooring 30. Current flow 171 flows under the draped body. The system, and peripherals, may be otherwise similar to embodiments described in regard to embodiments of FIGS. 1-14.

Referring now to FIG. 17, there is shown a drag-chute 190 that could be used as a body of the system in another alternate embodiment. The body may be secured by a mooring 30. Current flow 171 flows under the drag-chute. A leading float 17 maintains the depth at which the apex of drag-chute lines converge. The system, and peripherals, may be otherwise similar to embodiments described in regard to FIGS. 1-14.

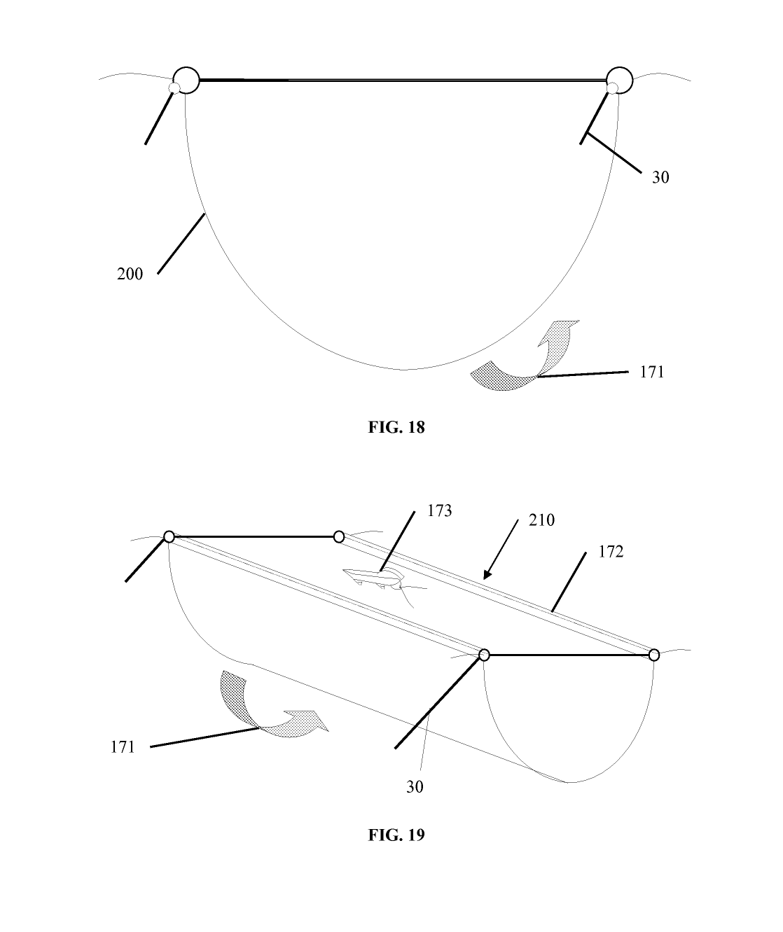

Referring now to FIG. 18, there is shown a Hemidome 200 that could be used as a body of the system in another alternate embodiment. The body may be secured by a mooring 30. Current flow 171 flows under the hemidome. The system, and peripherals, may be otherwise similar to embodiments described in regard to FIGS. 1-14.

Referring now to FIG. 19, there is shown a trough 210 that could be used as a body of the system in another alternate embodiment. The body may be secured by a mooring 30. Current flow 171 flows under the trough body. Many parts of the system, and peripherals, may be otherwise similar to embodiments described in regard to FIGS. 1-14. For larger applications, the trough buoyancy rims 172 could be roadways or tramways as, for example, to create a auto/rail link connecting Interstate Freeway I-95 and the Yucatan Peninsula. The calm debris free area inside the trough could be reserved for hydrofoil craft 173 and other vessels.

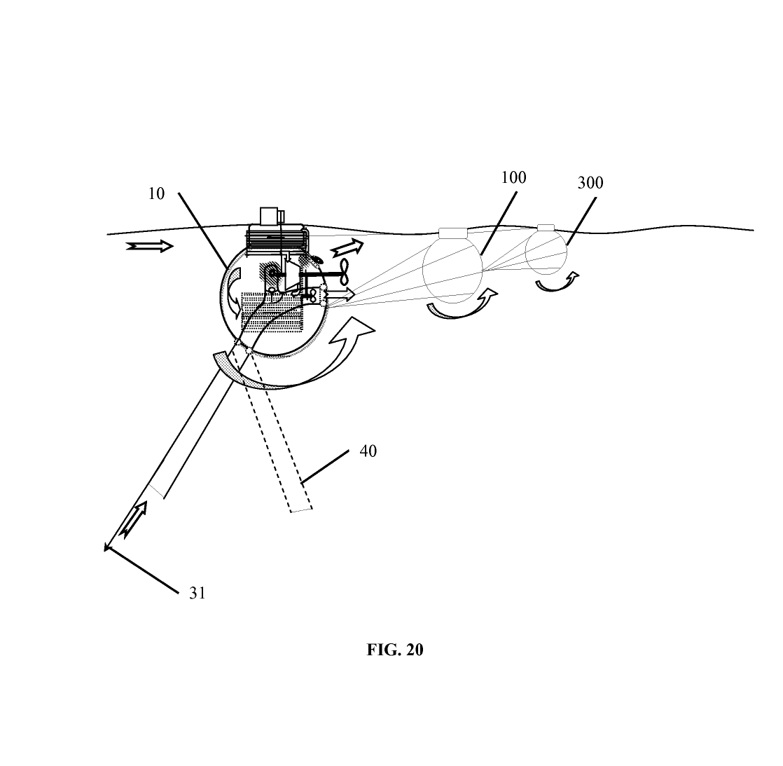

Referring now to FIG. 20, there is shown a series of orbs 10, 100, and 300 that are progressively smaller and work together to sequentially lift deep water to ever higher levels. The first orb in this orb train is moored to a mooring anchor such as 31. Subsequent orbs may be tethered to a preceding orb or separately moored as appropriate. A variation of this embodiment is self-propelled with the pipe 40 gimbaled backward, instead of forward, due to flow. The primary body and the trailing bodies could spin on an axis for energy production and/or added deep water lifting.

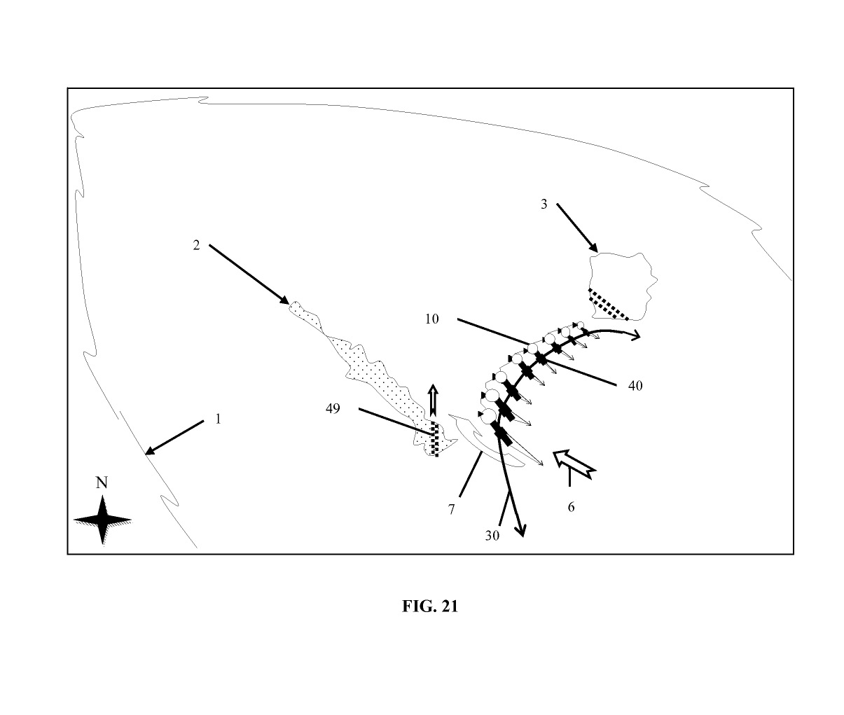

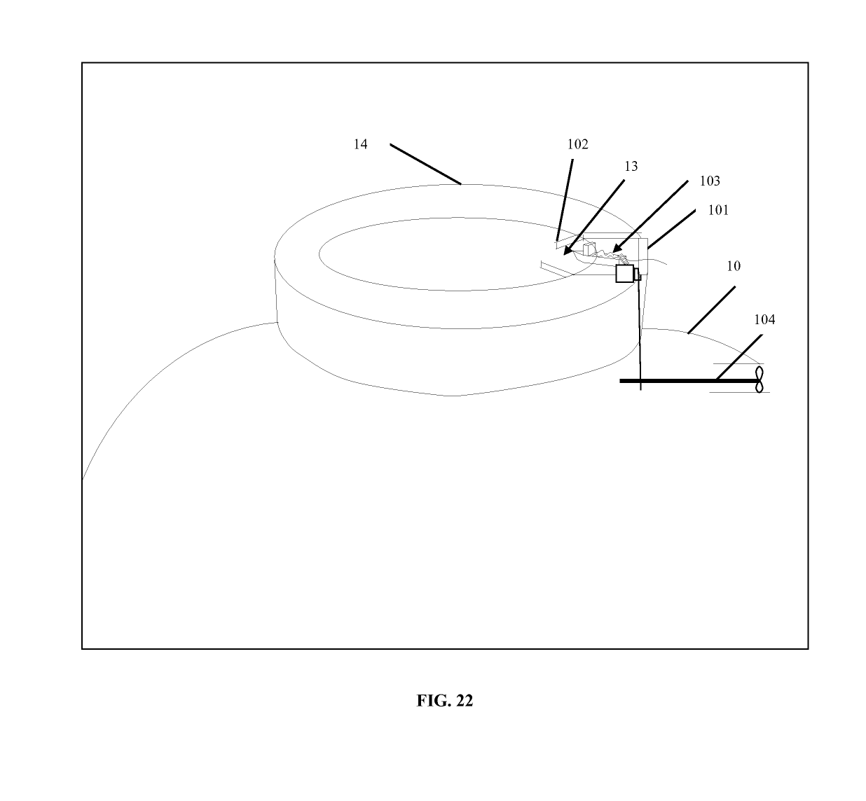

Referring now to FIG. 21, there is shown the use of orb bodies in a tidal current, such as in the Gulf of California, where each incoming tide causes deep water to rise around the orbs toward the surface and each outgoing tide allows subsequent surface water, several hours later, to flow freely out to sea. For the case of the Gulf of California, there is a ten mile strait between Isla San Lorenzo 2, and Isla San Esteban 3, between the Baja California peninsula 1 and the mainland of Mexico 4, where each tidal flow-field must narrow during ebb and flow. At least one Orb 10 could be placed in this channel such that when the tide 6 flows into the Gulf of California the orbs will drift into the narrow channel, against the pull of the mooring 30, causing considerable flow of more nutrient-rich water from under the orbs and through a pipe 40, upward toward the surface in the flow field 7. When the tide flows out of the Gulf of California, however, the orbs will drift into the wider region away from the narrow channel so that outbound flow of remaining warm surface water is relatively unimpeded as it moves out to sea. Over many tidal cycles, the result will be a net increase in nutrient-rich water in the Gulf of California (or other similar bay if applied elsewhere) for the benefit of fishing and kelp farm production for food and energy. All of the other energy and aquacultural technologies discussed in the present invention may be included as piggy-back technologies to enhance viability and improve the cost/benefit ratio for an application of this concept. In the case where an island, atoll, or other land structure is nearby, a conduit 49 that provides deep water into the flow field could be constructed by drilling through the land mass so that water from a distant, otherwise unaffected, part of the flow field (e.g. deep water) could be introduced into the region of the body. A one-way flapper valve could restrain water from flowing back down through the conduit so that the water in the conduit is always filled with deep (e.g. cold nutrient-rich) water.

Referring now to FIG. 22, there is shown a canal lock 13 that allows entry to the buoyancy collar 14 of an orb 10 by a vessel 103 through weir gates 101 and 102. The height of each weir gate is regulated to allow the entry of passing waves and current driven water into the buoyancy collar, and hence into the orb body, to maintain a slight pressure head inside the orb body due to wave action. A vessel, such as a kelp harvester filled with marine plant material, may request entry to the lock. Then the lock gates may be opened, or submerged, to let the keel of the vessel pass without allowing more water to escape than is necessary for entry. When there is no vessel entering or exiting the lock, the excess water from waves entering the lock may pass through a water turbine 104 to generate power before such water is allowed to exit, such as through a pressure regulated discharge port, preferably near the bottom of the orb body. The marine plant material may be deposited inside the orb body for conversion to fuel by processes such as fermentation, anaerobic digestion, pyrolysis and bio-hydrogen production.

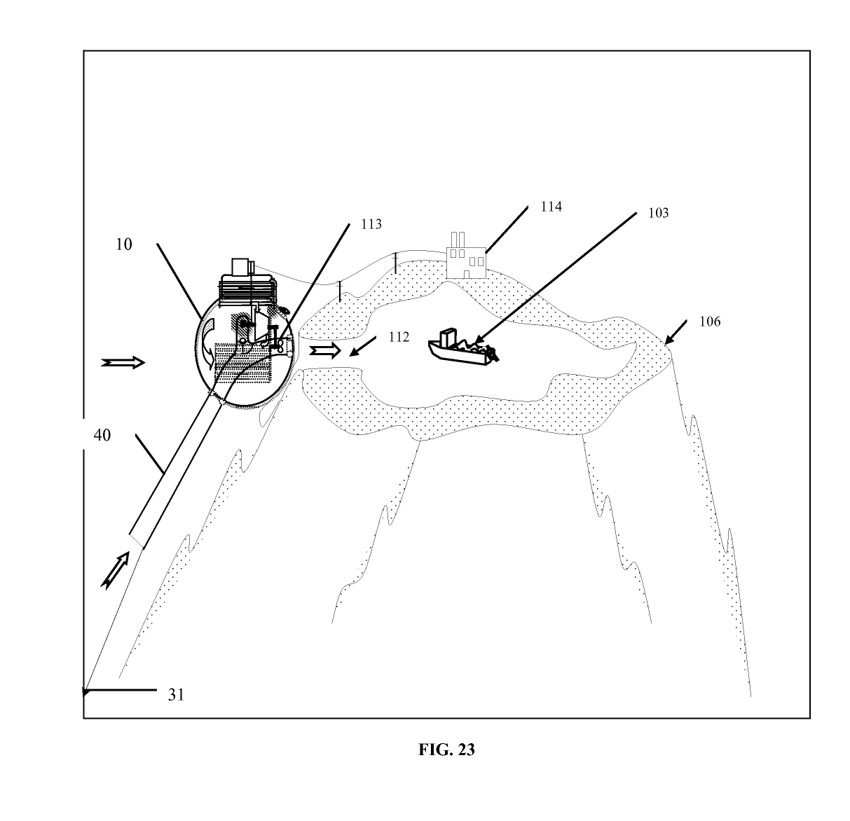

Referring now to FIG. 23, there is shown an energy self-sufficient application for regulating nutrient content for marine food and energy production in an island cove or atoll 106 by arranging for an orb 10 to drift into the cove entrance 112 as the tide comes in. Some deep water will then flow under the orb and some additional deep water will flow in through a conduit 40. If the orb seals against the mouth of a solitary cove entrance, tidal power will cause a pressure head to exist between the water level outside the cove and the water level inside the cove. In the case where tidal power raises the deep water through the conduit, a propeller or water turbine 113 may be driven to produce power to the generator shaft. As with other preferred embodiments of the present invention, power for additional pumping and electricity may be generated from the temperature difference between deep water and surface water, or from waves, wind, solar, marine plant conversion and the other methods mentioned for various other embodiments. Surplus power can be provided to facilities on the orb or on land such as an industrial facility 114 as desired.

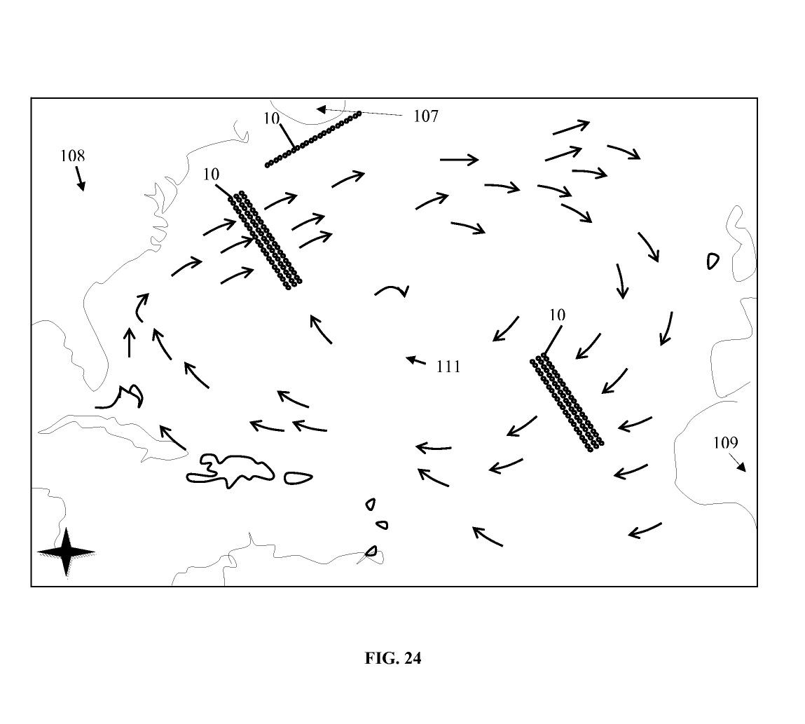

Referring now to FIG. 24, there is shown an application for regulating the temperature of the earth's atmosphere by first regulating the temperature of the ocean surface with which the atmosphere is in contact—such as to avoid global warming despite increases in carbon dioxide levels from fossil fuel emissions by human activity. The Sargasso Sea 111 circulates in the Atlantic Ocean between North America 108 and North Africa 109. An array of more than one orb body 10, is installed in several locations, such as offshore from North America and offshore from North Africa, to raise cold deep water for atmospheric temperature regulation. An additional array of orb bodies could be placed at the base of glaciers to insure that ice melt from glaciers, such as from Greenland 107, would combine with seawater so as to increase density and therefore no longer float buoyantly above the seawater—which floating can interfere with the Gulf Stream and disrupt flow. (Such fresh water barrier orbs would no longer be necessary once global warming is curtailed because the glaciers would then no longer melt at the accelerated rate that has recently caused the Gulf Stream to stop flowing.) If the Gulf Stream is interrupted, as has happened recently, one concern is that dangerous localized cooling may occur in Europe. Importantly, in light of this phenomenon, maintenance of the Gulf Stream flow rate—at a regulated temperature—could be seen as both preventing global warming and preventing a localized ice age in Europe. Once the Earth's temperature is stabilized to a desired level, then many more of the orbs could be decommissioned at a rate commensurate with proper re-stratification of the oceans to achieve a temperature level that can maintain planetary ice sheet reflectivity despite prevailing atmospheric carbon dioxide (and methane) levels for any decade in question. Sargassum kelp (growing naturally in the Sargasso Sea), and any other marine plant material that is grown in the nutrient-rich water (raised by the orbs and attached conduits), can be harvested and stored in the orb bodies for conversion to food and energy products. Industry, commerce and residential living can be supported by the orbs acting as platforms in the ocean that are self-sufficient with regard to energy and food. Any icebergs floating into the orb deployment region can be towed away in the same manner that icebergs are currently towed away from oil drilling platforms in cold climates. Alternatively, icebergs could be captured and used as orb bodies. Another alternative is to collect the icebergs inside of orbs and later release the cold low-density fresh water, as a result of melting, into a hurricane hot spot to reduce hurricane intensity. Since many hurricanes are currently generated off the coast of North Africa and these hurricanes often blow westward toward North America, one early effect of working to reduce global warming using orbs in the Sargasso Sea will be to reduce the intensity of hurricanes traversing the Atlantic Ocean.

Referring now to the general technology of the present invention as an Ocean Resource Balancing (ORB) technology, several embodiments of the Fluid Property Regulator of this invention can be further described by considering various features of this instantiation in free-flowing narrative. Firstly, the ORB technology can be expanded to a configuration of multiple orbs by forming a String-of-Pearls (first shown in FIG. 1) or by assembling orbs into clumps (first shown in the conglomeration embodiment of FIG. 4) or by making trains of successively smaller orbs in the flow stream (as shown in FIG. 20).

The latter orb-train configuration, with successively smaller orbs downstream in a line, provides that the center of the output profile from one orb becomes the input for the bottom of the flow field of a subsequent orb, and so on for several orbs, until the surface layer of the ocean is finally made up largely of water that was originally at the depth of the bottom of the first orb even if the density stratification, in a flow of insufficient Reynolds number, were to be too great for lifting such water directly to the surface using only a single orb in the flow field.

In general, the orbs are filled with water at slightly elevated pressure to insure that each orb body maintains its shape in a flow field. Some additional deep water is then injected into the flow field using a conventional pipe. If, however, such a pipe is constructed with a double wall design, as described in terms of components in the double-walled pipe description above, then suction could be produced that causes flow through a much larger pipe suspended from the orb. By pumping water out of the top of the pipe, deep water will then enter through the bottom of the large pipe without wall collapse. Furthermore, the double walls could be filled with water of one type while the orbs are filled with water of another type while the pipe itself could transport water of a third type. The maintenance of different types of water could be a basis for creating a Carnot cycle as well as a way of storing different materials for various purposes.

The ORB technology also employs a buoyancy/ballast subsystem and may have vanes that ride the current to maintain submergence depth. Additional lift from hydrofoils that connect the orbs may also counteract the submergence effect of increases in current velocity over time. A buoyancy ring, to the extent of protrusion above the ocean surface, may provide shelter to ocean vessels at sea in larger ORB implementations.

For the Carnot cycle embodiment, the ammonia vaporizes at the warm surface water temperature as it flows through tubing that is embedded into the buoyancy collar skirt atop the orb. Then the ammonia passes through condenser coils (e.g. titanium tubing) embedded inside the orb where cool deep water returns the ammonia to liquid after the vapor directly drives the shaft of a supplemental cold water pumping subsystem to inject supplemental cold water for additional cold water flow into the turbulence behind the system for property regulation.

Since the warm and cold heat exchanger coils are embedded in underwater structures, the buoyancy required to compensate for their submerged mass is significantly less than if the cold water was brought above deck and then contained in heavy traditional boiler and condenser units. In a variation on this concept, alternate orbs can be filled with warm surface water and cold deep water, respectively, so that tubing for heat exchange in the Carnot cycle is exclusively contained within the large orb structures rather than having the heating coils exposed to wave action in a separate skirt as shown in the figures here. Wave action does, however, have the advantage of increased heat transfer.

Another additional feature for increasing effectiveness of material property regulation includes the farming of marine plants on grid structures in the nutrient-rich water produced by such water property regulation. When a string or array of orbs are interconnected with underwater false bottom grid lines, such as can be made from polypropylene ropes, marine plants can be grown and harvested for long-term CO₂ fixation or for methane and other energy production to increase the pumping of deep water (e.g. via gas turbines) or for other energy uses. Energy produced by any manner can be used to drive additional pumps for raising deep water, propulsion or for generating electricity and other purposes. The energy extracted from the ocean may also be used for commercial energy and food processing.

The symbiotic use of multiple energy sources to achieve water property regulation and to produce system or commercial energy is also combined with ocean food production. Marine plants, for example, not only provide a source for energy but also a food source directly for consumption, and indirectly for the fishing industry.

An instantiation of the material property regulator system for an application producing energy and reducing the size of landfall hurricanes in the Gulf of Mexico is shown in the figures here. While individual features of the ORB technology are viable alone, the integrated whole is particularly symbiotic because many benefits result simultaneously from the invention's water property regulation characteristics. The ORB technology uses ballasted barriers with or without temperature differential and marine plant material energy supplements to cause the raising of deep water and temperature regulation as a way to produce energy and food byproducts while mitigating hurricanes. A String of Pearls can be joined in a line or array such that they produce an increased aggregate effect. An archipelago of orbs can be aligned in a particular configuration (e.g., the shape of a sail) to cause diversion of water-currents as well as water property regulation.

For hurricane regulation, in particular, a properly placed String-of-Pearls implementation will reduce warm surface water temperature to a cooler average (i.e. to a temperature level that is between the original warm surface water temperature and the original cool deep water temperature), thus preventing the formation of hot spots such as the hurricane producing Inner Loop region of the Gulf of Mexico. The material property regulator will thereby reduce the formation of hurricanes that might otherwise gain power over hot-spot ocean areas such as the Inner Loop Eddy Current. The technology does not run the risk of causing the reverse effect, to generate hurricanes, because cool water must underlie warm water in a steady state due to density differential. Therefore, a combining of ocean layers will result in a lowering of temperatures rather than a raising of temperatures in the surface layer of an ocean.

If surface water can be combined with cold deep water to achieve a temperature that stays below about 80 degrees Fahrenheit in the top 200 feet, hurricanes will not form. Incremental improvements in reducing hurricane category size will also result from each degree of cooling in the range above 80 degrees. Thus, a String-of-Pearls is capable of providing hurricane regulation and dissipation. In the Gulf of Mexico, nearly all hot water is brought into the hurricane producing Inner Loop region through the narrow Yucatan Strait where an archipelago of orbs could be strategically located. At a larger scale, the ORB technology is capable of providing global warming regulation to the extent that one or more forms of the ORB technology are implemented to a greater or lesser extent as appropriate to circumstances. Further, as a byproduct of lifting very deep water via the Fluid Property Regulator (i.e. when water is brought from the oxygen maximum zone), energy and food production will be increased because of nutrients brought up from an oxygen maximum zone in deep waters of the world's oceans. One crucial byproduct of raising deep water is net CO₂ fixation (net carbon-dioxide removal from the atmosphere) due to increased marine plant material growth from the raising of deep nutrient rich waters. In addition to reducing this atmospheric temperature affecting gas, the use of the marine plants as a replacement for fossil fuels, constitutes a form of renewable energy. Kelp, as an example, grows up to 2 feet per day and provides hydrocarbon marine plants that can be converted to natural gas and other petroleum-equivalent products. Kelp is now used extensively as a source of algin texturizer (e.g. in ice cream, bear and paint) and can be a source of up to 40% of a sheep's diet.

One application of the Fluid Property Regulator invention may be to regulate the property profile of tidal currents flowing into a tidal basin such as the Gulf of California. In such an application, during the inflow of the tide a string or array of orbs may be moored such that they drift into a narrow channel such as between an island and the mainland or peninsula so as to cause sizable property profile regulation such as the raising of nutrients. Then, as other warmer (nutrient-depleted) water inside the tidal basin subsequently flows out of the tidal basin, with the receding tide, the orbs could be allowed to drift to a wider region so that outgoing surface water is less impeded. Over time the repeated introduction of nutrient-rich water during inflow and nearly unimpeded loss of surface water during outflow would have a net effect on the increase in nutrient content for the tidal basin as a whole. This could enhance fishing and provide a basis for growing kelp as part of an energy and food program.

The ORB technology of this Fluid Property Regulator invention encompasses various designs to regulate material properties such as by combining deep (e.g., cool and/or nutrient rich) water with surface (e.g., warm and/or nutrient depleted) water for purposes such as lowering the surface temperature to hinder hurricane formation and/or raising nutrient levels to improve aquatic growth in a region.

Also included is the transfer of cold water to a region of warm water so that a Carnot cycle can be established for energy usage to drive a pump or generator, and the transfer of nutrient rich water to provide nutrients to facilitate the growth of marine plants for energy and food, e.g. marine plants for hydrocarbon production and CO₂ fixation (atmospheric carbon-dioxide removal) as well as for fishing-ground enhancement and other food production. The combination of these featured purposes, as well as others described separately, allows water property regulation to be a basis for a more encompassing design for ocean energy, food farming and port-at-sea activities worldwide.

The concentric in-line booster pumps included in this invention take power out of the external current, as water passes along the outside of the deep-water pipe. These water wheels use current power to drive internal propellers (impellers) to boost flow rate within a supplemental pipe. In the case where the mouth of the pipe is held at a depth, and the tail is held at the surface, this power boost produces increased lower-level (cold) flow rate, and also reduces higher-level (warm) water flow, so that the total net amount of cold water is increased in the surface layer of water downstream of the system (e.g. into the Inner Loop region of the Gulf of Mexico where Hurricane Katrina built up from a category 0 storm to a category 5 hurricane). External blades are connected to internal blades in a concentric arrangement with the concentric blades separated from one another by seals that allow the shaft connecting the blades to rotate with minimal water loss through the seals.

One feature for maintaining water pressure inside each ORB apparatus includes the use of a unique wave collecting system to raise water height inside the buoyancy collar. Impinging waves and current surge will overflow the wier gates, bringing in added water to the orb interior to compensate for leakage and to supply supplemental power.

There may be advantages to rotating the orbs on their axes (which may be canted) under the influence of the current such that the rotation causes pumping action to raise/submerge water to a different strata level.

The use of a specially designed Venturi Suction Device in this invention is that it guides surface water through a constriction, attached to the tail of the pipe, such that raised water is drawn from the tail into the surface stream for subsequent material property regulation at greater rates to increase property regulation and reduce the amount of warm water passing near the apparatus. The tail position in the current flow stream is controlled by modifying the relative orientation of the Venturi and discharge nozzle so that the ocean current causes the discharge nozzle to move to a desired orientation using feedback control techniques for selective discharge positioning.

The use of a design variation that reduces the amount of material needed to construct a large deep-water pipe creates a fluid-filled space between two concentric pipe shells. The relatively thin outer and inner shells are separated by a fluid such as seawater that creates the effect of added wall thickness. Such a water-wall is held at elevated pressure between the two shells to increase stiffness. The elevated pressure is achieved by pumping action under pressure and/or by maintaining a higher water line between the walls than at sea-level. A comparatively small amount of water pumped into the space between the shells, above sea-level, is possible with the shells rising above the sea surface. The stiff water-wall is used such that when a large amount of water is pumped out of the inside cavity, water begins to flow into the bottom of the double-shell pipe as replacement. Thus a high rate of pumping can be maintained at the top of the pipe in a way that is similar to the phenomenon that causes water outside a straw to push water up the straw when a vacuum is formed above the straw. Thus water is driven up from the bottom of the pipe by the water pressure of the surrounding sea. The pipe does not collapse under suction because ties between the two shells insure that the inside shell does not cave inward. Vacuum cavitations are avoided because the pumps simply pump water out from just below the surface level inside the inner shell (which is better than sucking water from the top of a long pipe). In this way a small amount of thin skin material, forming the inside and outside shells, provides the same stiffness as a much thicker walled pipe of ordinary design and the arrangement allows pumping from the surface rather than from the base of the pipe.

To hold the lip of the deep-water pipe above sea-level, cables wrap over ram tensioning devices which allow the buoyancy collar to lift with wave motion while the pipe remains essentially stationary. This may be particularly important for the case where a horizontal watermill is deployed. The ram tensioners retract as required to accommodate wave motion, but they extend, by springing back, to insure that slack is never created in the support cables as the excess cable tension subsides.

The waterwheel is of larger diameter than the pipe and drives pinion gears connected to each pump shaft as the rack gear of the water wheel rotates around the pipe under the influence of the surface current. The rack gear of the waterwheel is embedded in a secondary buoyancy ring, so that this rack ring drives the pump pinion gears from underneath these gears, as the waterwheel rotates below the waves while pressing up from below. A universal joint allows the gears to remain fully engaged at all times.

The concentric waterwheel can also be rotated and modified to become a horizontal waterwheel with multiple stages of gearing such as planetary gearing. An additional stage or multiple stages of geared internal blades progressively increase the pressure and flowrate utilizing the power of the external blades. A planetary gear arrangement, for example, translates the low revolutions per minute (RPM) into high RPM by mounting the outside blades to the outside of the planetary gear assembly such that the output shaft of the planetary gear drives the internal blades (or an Archemedian screw) at high speed.

The use of air compression to submerge the entire grid structure, or even the orbs themselves, below the wave zone during major storms is important to survival of design limit storms or other emergencies. In addition to an embodiment for lowering orbs below the wave zone using cables, emergency submergence can also be accomplished by compressing air inside the buoyancy collar (which normally holds up the top of the wave pump or orb) until the collar becomes negatively buoyant. Conventional pumps or the wave pumps themselves may be used to compress the gas for buoyancy control. As the dispersion network (and/or orbs themselves) submerge, marker buoys remain at the surface with air tubes that remain above water to decompress the buoyancy collar after the storm passes. These marker buoys ride out the storm while keeping the system from sinking further. Individual buoys may submerge in each wave, but on average, the buoyancy of the marker buoys is enough to keep the system from continued descent. Throughout a 2000 year storm, for example, the dispersion network (or entire orb system) may remain moored safely below the surface, out of the wave zone.

The use of novel wave pumps provides several features. In addition to nutrient dispersion and buoyancy control, these pumps could be located such that they also pump water into the area between the two shells for the double walled pipe configuration. As wave pumping continues and the pressure head becomes great enough between the two shells, pressure relief valves near the bottom of the pipe could allow the water to discharge into the surrounding water at depth. If the water pumped between the two shells is warm water, such warm water will naturally rise, once discharged at a deep location, and will then draw with it additional cold deep water toward the surface for added cooling effect. Working in conjunction with the compression feature of the wave pumps, the extra pumping of water between the shells will begin submerging the whole structure, so that the remaining buoyancy diminishes and the amount of air compression needed to submerge the structure is reduced.

A unique assembly of tubing allows a Carnot cycle to boost water pumping action by boiling ammonia at the warm surface temperature in a skirt or in an orb. The boiler tubes are integrated into the base of the buoyancy collar so that the warm-water surface current flows over the tubes. The condenser tubes are integrated into the cavity inside the orb, around the cold deep-water pipe, so that cold water flows over these tubes prior to discharge from the orb. During periods when cooling has been sufficient, and further build-up in the reservoir of cold water is not desired, this Carnot engine can be used to drive an electric generator for sale of power to an electric grid of nearby cities (such as Cancun, Mexico for the Yucatan application).

The mooring lines can contain electrical cables such as those that carry power between states on land. Power cables from the Inner Loop region to the Yucatan Peninsula, Texas and Florida, for example, would be approximately the distance of cables from Colorado to California, Oregon and New York. By adjusting the lengths of these mooring/power cables, the position of a String of Pearls installation could be continuously adjusted to maintain an optimal position relative to slight current pattern changes. If the mooring/power cables culminated at a facility with railroad tracks, for example, the length of the mooring/power cables could be adjusted by changing the position of railroad cars as anchor points.

An optional cold-water dispersion trough or dispersion tube may stretch downstream from the cold-water outlet of the deep-water pipe and provide a wide area for dispersing the raised water into the far-field of the Fluid Property Regulator. By discharging to one side of the trough, only, the cold water discharge jets might also guide the trough and the warm surface current as a localized propulsion system. Indeed the trough could also guide much of the warm surface water directly toward the Florida Strait thus bypassing the Inner Loop Eddy and having mostly colder deep water flowing from underneath the trough enter the Inner Loop region.

The trough may be made of plastic or fabric and might maintain its semi-circular cross section as the water level inside the trough is raised compared to the water level outside the trough. Cold water pumped into the trough might be discharged from ports on one side of the trough (e.g. the Northwest side in the Gulf) to put pressure against the surface current and guide it to a destination (e.g. through the Florida Straits). The depth of the dispersion trough is chosen to be deeper than the 80 degree isotherm line so that water warmer than 80 degrees is deflected by the trough and only colder deep water flows under the dispersion trough into the targeted area.

A series of buoyant floats may hold up the cold-water dispersion tubes or trough while providing wave-powered discharge pumping assistance for distributing the cold water evenly throughout the desired dispersion region (e.g. in the Inner Loop region of the Gulf) and providing some propulsion. While providing a distributed force pushing against the surface current to guide the trough and thus the current, complementary Corriolis forces also act to steer the current (e.g. eastward as the current heads north through the Gulf). One unique feature of these wave pumps is that if very large waves begin to form (e.g. during a storm), the pumping action activates compressor cylinders that cause the air in the floats to pressurize such that the floats begin to sink out of the wave zone. Once below the wave zone, in the absence of wave pumping action, the floats begin to depressurize so that buoyancy returns and the floats rise back toward the surface where the cycle repeats itself until calmer seas prevail. With all of the floats acting in this mode, the dispersion trough (including the cold water pipe outlet suspended from similar floats as described above) is effectively lowered beneath the wave zone during storms. Higher density cold water causes the trough to exhibit stiffness even while the trough is submerged. In calm periods, the trough floats to the surface and holds its stiffness due to a slight pressure head inside the trough due to the pumping of water into the trough. In a very large scale application, the dispersion trough may be maintained with its sides above water such that an airport, roadway and/or train system can be supported (e.g. a Mobile Offshore Naval/Air Force Base or a highway over the sea from Florida to the Yucatan Peninsula). For large troughs the structural shape may be achieved using a conglomeration of smaller orbs that are more easily manufactured and installed than single large swaths of flat fabric.

The network of mooring cables has a unique feature that the relative lengths of the mooring cables can all be controlled to dictate the relative position and orientation of all of the other system components relative to each other and relative to the surrounding terrain in the flow stream. In one arrangement, for example, three-point moorings for a progression of prototypes in an archipelago, are controlled such that the collective interaction of flow passing by each unit, progressively guides the surface current in a desired direction. Like the sails of a multi-masted schooner, the position of each orb is determined by inhaul and outhaul lines. The entire archipelago can be oriented to “luff” in the current, or can be “close-hauled” to cause desired current flow patterns and cold-water dispersion plume characteristics.

Rudders on the mooring buoys, or deflecting otter boards (vanes) along the mooring lines of the main pipes (and the dispersion pipes if included), may be controlled to steer the orbs and to damp out any fluid flow vibration effects while spreading the orbs apart against current forces that could otherwise pull them together. Otter board vanes could also be used to guide water in a desired direction such as up into the cold water inlet or directly up into the Fluid Property Regulation area. The mooring lines, for example, can have otter boards in deep water that are angled to drive cold water to the west (into the Inner Loop), while otter boards near the surface, on the same or different mooring lines, can be angled to drive hot surface water east toward the Florida Straits.

Grid lines, connected between mooring systems, are included to grow marine plants such as Giant Kelp (Macrocystus mexicanis or Macrocystus perifera). The grid lines, and/or small submerged buoys attached to the lines, are impregnated with spores of the preferred marine plant species. Depth of the submerged lines and buoys is regulated by wave power action using feedback control to determine the extent of air compression inside the buoys. As the marine plants grow in length, the line depth may be altered accordingly. During harvesting of the marine plants, in calm seas, line depth may be raised to allow greater volume to be harvested. As the plants coppice after harvesting, and grow again in length, the line depth may be once again altered to an appropriate depth.

The pipe may be gimbaled at its connection to the orb. Because of its gimbaled connection, the larger pipe may then assume any angle in the current without causing the bending of pipe connections to the orb. A spherical pool structure may be constructed at the interface with a ring of small umbilical pipes that allow flow if water inside the orb is pumped out of the orb, for the double walled orb arrangement similar to that of the double walled pipe. The surrounding water pressure then pushes water through each small umbilical pipe, without separate pumps, into the sphere because of the head-differential between the outside and inside water level. The gimbaled region may be open to the atmosphere at the top and can be re-gimbaled to a vessel of opportunity, such as a semi-submersible as appropriate.

Two orbs may be equipped with water pockets similar to those of a horizontal water wheel, and the orbs may rotate individually about different axes such that one orb submerges surface water while another raises deep water due to strakes or Archimedean pump action.

Excess electrical power can be generated after running deep-water pumps. A mechanism for attaching a large generator, while detaching extraneous units, is achieved by rotating double lines about a buoy pulley and an anchor pulley to raise components into maintenance position for alteration near the surface.

Excess electricity could be sold to a nearby power grid or used on site for high power consumption customers such as for powering the energy-intensive conversion of alumina to aluminum. A semi-submersible with an industrial plant on board could be moored to the orb mooring or otherwise position itself, as appropriate, to take advantage of energy produced by the orb facilities.

In one scenario, the gimbaled mechanism for a deep-water pipe could be disconnected quickly from the orb and reattached temporarily to a vessel such as a semi-submersible. Then after using the energy for a time, the pipe could be dropped or reattached to at least one orb, while the vessel proceeds to port for factory repairs, or to deliver product to market, or in the event that a major storm is imminent.

The orbs internal space may be used as a building structure or storage space for any needed purpose requiring a protected environment at sea. Large orbs could be used as a buoyant structure upon which or around which to build airports, runways, roads, material handling cranes and other surfaces or underwater structures. The orb facilities could be placed in an arc that guides (redirects) water flow to avoid the emergence of a secondary water-current loop or eddy such as the Inner Loop Current.

Among ways to pump water into the orbs, the buoyancy collar could serve as a horizontal watermill to pump water for the purpose of maintaining pressure head inside the orb as water seepage creates losses over time. Additional lift from hydrofoils that connect orbs could counteract the effect of increases in current flow rate.

The orb system may have an ORB set-point specification algorithm that takes as its input the latest published figures regarding the amount of carbon dioxide, methane and other undesirable gases reported to exist in the atmosphere, as published by experts such as the Nobel prize winning Intergovernmental Panel on Climate Change, and this algorithm may output, by an algebraic and otherwise mathematical calculation, the number of orb bodies and the velocity of these bodies needed to produce a required average atmospheric temperature needed to properly adjust the size of the ice sheets of a planet such as Earth by ocean property regulation of atmospheric temperature using at least one Fluid Property Regulator installation. The algorithm may use standard interpolation and extrapolation techniques based on a look-up table relating published ocean temperatures corresponding with ice cap size in the historical record. The algorithm may further use control theory techniques to determine a step response with acceptable overshoot (e.g. as the inverse Laplace transform for a step response based on a system transfer function) for proper re-stratification of a planet's oceans, to achieve a desired overall steady state fluid property regulation balance in the oceans of the distant future.

To help determine the proper set points for this property regulation system. An encrypted balloting device may use voice recognition technology and cellular technology, to make possible the collection of one unique vote per individual on a planet. This technology will be based on voice characteristics for the purpose of ratifying a decision of global importance—such as a decision to assign an atmospheric temperature set point to the Fluid Property Regulator system.

Many other features and their advantages will be apparent to skilled artisans.

What is claimed is:

1. A method for regulating a property of a material that is external to a body, said method comprising:
placing the body in proximity to the material to cause displacement of at least one portion of the material due to a relative motion between the body and the at least one portion of the material in a downstream far-field region of a flow stream.

2. The method of claim 1, further including
securing the body to an outside reference point thereby causing the relative motion between the body and the material in the flow stream.

3. The method of claim 2, wherein the flow stream is an ocean current.

4. The method of claim 1,
providing a propulsion system that provides thrust to create the relative motion between the body and the external material.

5. The method of claim 1, further comprising
transferring a portion of the external material from one location to another location relative to one other portion of the external material due to a flow of the external material relative to the body in the flow stream.

6. The method of claim 5, wherein the another location is a new elevation in an ocean current.

7. The method of claim 1, wherein the property of the material is the density profile of the material.

8. The method of claim 1, wherein the property of the material is the temperature profile of the material.

9. The method of claim 8, wherein the material is seawater, and wherein the temperature profile of the seawater includes the temperature profile of the top layer of ocean.

10. The method of claim 9, wherein the temperature profile of the top layer of ocean includes a reduced temperature in an area of ocean that is in the path of a potential hurricane so as to reduce the intensity of the hurricane.

11. The method of claim 8, wherein the temperature profile includes at least one thermocline, wherein the material is a water current.

12. The method of claim 1, wherein the property of the material is the salinity profile of the material.

13. The method of claim 10, wherein the salinity profile has at least one halocline, wherein the material is a water current.

14. The method of claim 1, wherein the property of the material is the chemical make-up profile of the material.

15. The method of claim 12, wherein the chemical make-up profile is a nutrient content profile, wherein the material is a water current.

16. The method of claim 1, further comprising generating supplemental power from at least one of water-current power, wave power, temperature-differential power, biofuel power, tidal power, wind power, direct solar power, indirect solar power, hydrogen fuel power, salinity differential power, geothermal power, nuclear power and fossil fuel power.

17. The method of claim 1, further comprising generating supplemental power from a water turbine located near the body.

18. The method of claim 1, further comprising generating supplemental power from one-way gating, said gating permitting one-way flow for a fluid that enters an enclosed region of the body, and said gating preventing the fluid from leaving the enclosed region without the fluid passing through a power generation apparatus.

19. The method of claim 1, further comprising generating supplemental power from wave pumping wherein wave action causes floatation to rise and fall and thereby provide pumping action of fluid through at least one one-way valve and accompanying power generation apparatus.

20. The method of claim 1, wherein the body is hollow, and the method further comprising storing a marine plant material inside the body.

21. The method of claim 20, further comprising converting the marine plant material to fuel by at least one of anaerobic digestion, fermentation, pyrolysis and biohydrogen generation to render the marine plant material a usable energy product.

22. The method of claim 20, further comprising holding carbon content of the marine plant material inside the body at a long-term containment location.

23. The method of claim 1 wherein the body has no nearby surface to provide partial enclosure of the material that is external to the body.

24. The method of claim 1, wherein the step of placing the body includes placing at least two bodies as an archipelago and wherein the collection of bodies redirects a surface fluid away from a region of interest relative to the archipelago.

25. The method of claim 1, further comprising causing the body to rotate such that the rotation causes a pumping action to transport water to a different strata level.

26. A system for regulating a property of a material, the system comprising:
a body in proximity to the material so as to alter a position and property of at least one portion of the material in a downstream far-field region of a flow stream due to a relative motion between the body and the material, wherein the material is external to the body.

27. The system of claim 26, further including a securing device connected to the body and to an outside reference point thereby causing the relative motion between the body and the material in the flow stream.

28. The system of claim 27, further including a propulsion subsystem that provides a thrust to relieve mooring tension in the securing device.

29. The system of claim 26, further including a propulsion subsystem that provides a thrust to create the relative motion between the body and the material.

30. The system of claim 26, wherein the body is made of a flexible outer skin material and is filled with a fluid at a pressure higher than a pressure surrounding the body so that the body can maintain a shape.

31. The system of claim 26, wherein the body is positioned so that the material flow relative to the body is such that a portion of the material is moved from a first location to a second location of a different elevation, relative to another portion of the material, due to a flow relative to the body in the flow stream.

32. The system of claim 26, wherein the property is a density profile.

33. The system of claim 26, wherein the property is a temperature profile.

34. The system of claim 26, wherein the property is a salinity profile.

35. The system of claim 26, wherein the property is a chemical profile.

36. The system of claim 35, wherein the chemical profile is a nutrient profile.

37. The system of claim 26, further comprising at least one of a sensor for sensing a position, velocity, acceleration, flow, image, infrared, temperature, salinity, chemical, nutrient, pressure, and/or force; a dye dispenser; and a dye detector.

38. The system of claim 26, wherein the body is used for storage.

39. The system of claim 26, further comprising a buoyant member suitable for supporting the body.

40. The system of claim 26, further comprising a platform, and a buoyant member wherein the buoyant member supports the platform.

41. The system of claim 26, further comprising at least one additional body, and wherein the at least two bodies are attached to one another.

42. The system of claim 27, wherein the securing device is a tiara mooring, said tiara mooring including
an anchoring fixture to an outside reference point,
a cable, and
a connector attached to the body to make a collective arrangement.

43. The system of claim 27, wherein the securing device includes a pipe that both carries mooring tension and serves as a conduit for a material flow.

44. The system of claim 43, wherein the material flow raises deep water.

45. The system of claim 27, wherein the cable of the securing device carries mooring tension and an electrical current between the body and the outside reference point.

46. The system of claim 27, wherein the at least one mooring includes a plurality of moorings, and wherein the length of at least one of the moorings is adjustable relative to the length of at least one other mooring and a reference point to affect a repositioning of the body.

47. The system of claim 26, further comprising a lift mechanism attached to the body to offset any negative buoyancy.

48. The system of claim 26, further comprising a buoyancy device, wherein the body has a top near an interface of the material, and wherein the buoyancy device is positioned near the body top to provide an upward vertical force to the body.

49. The system of claim 26, further including an adjustment mechanism that is foil shaped such that its flow stream angle of attack is adjustable to affect a positioning alteration of the body in the flow stream.

50. The system of claim 26, wherein the body is hollow and may be partially filled with a high density material is otherwise filled with a low density material to achieve desired buoyancy.

51. The system of claim 26, further comprising at least one one-way flow device that allows a material flow through a surface of the body without allowing a material flow in the reverse direction.

52. The system of claim 26, further comprising a pressure relief device that allows material to cross a barrier of the body if the absolute value of a differential pressure inside the body relative to a pressure outside the body exceeds a specified threshold.

53. The system of claim 26, further including
a one-way seal that allows the material to enter the body, and
a pressure relief mechanism that allows the material to escape from another part of the body to achieve material transfer from one location to another.

54. The system of claim 26, further including a one-way seal apparatus to maintain a higher fluid pressure inside a body of the system to maintain body shape against the force of fluid flow against a relatively flexible said body in a flow stream.

55. The system of claim 26, further including at least one top having segments, said segments being partitioned from one another by canal locks for allowing a craft to enter and leave a protected area created by the breakwater effect when the body is deployed in the material subject to waves in an ocean.

56. The system of claim 26, further including a conduit that passively introduces additional flow to the Fluid Property Regulator from a region of the material that might not otherwise become directly influenced by the body.

57. The system of claim 26, further including a second body that is connected to the first body in sufficiently close proximity to cause Venturi suction between the bodies to passively draw a flow through a conduit from a region of the material that might not otherwise become directly influenced by the body.

58. The system of claim 26, further including a power unit that produces power for generating additional material transfer and regulation.

59. The system of claim 26, further including a conduit having a powered pumping mechanism that actively introduces additional material from a region of the material that might not otherwise become directly influenced by the body.

60. The system of claim 26, further including a second body and a connector that connects the two bodies and provides a mounting point for a platform.

61. The system of claim 26, further comprising a water turbine for generating supplemental power.

62. The system of claim 26, further comprising a one-way gating unit that generates supplemental power, said gating permitting one-way flow for a fluid that enters an enclosure, and said gating preventing the fluid from leaving the enclosure without passing through a power unit.

63. The system of claim 26, further comprising a floatation that is designed to rise and fall with wave action, thereby providing supplemental wave power.

64. The system of claim 26, wherein the body is used to store a material that is different from the material outside the body.

65. The system of claim 64, wherein the stored material is cold seawater and the material outside the body is warm seawater.

66. The system of claim 26, further comprising a skirt of heat exchanger tubing to induce heating of a secondary working fluid for a Carnot cycle boiler unit.

67. The system of claim 26, further comprising a skirt of heat exchanger tubing to induce cooling of a secondary working fluid for a Carnot cycle condenser unit.

68. The system of claim 26, further comprising external structures near the body to allow marine plant farming in a nutrient-rich property-regulated material region downstream of the body.

69. The system of claim 26, further comprising a connector to the body that provides a platform for supporting a containment region near the body, wherein the platform is used for fishing and aquaculture farming in the downstream nutrient-rich property-regulated fluid region.

70. The system of claim 26, wherein the body contains a marine plant material.

71. The system of claim 70, wherein the body contains at least one of anaerobic bacteria, fermentation agents, pyrolysis units and biohydrogen generation units to convert the marine plant material to an energy product.

72. The system of claim 26, wherein the carbon content of the marine plant material, is held inside the body for subsequent transfer to an ocean floor canyon at the end of the body's life cycle so as to permanently remove carbon from the atmosphere.

73. The system of claim 26, further comprising at least one additional body, wherein the at least two bodies are deployed as an archipelago and thereby collectively cause redirection of a surface fluid away from a region of interest relative to the archipelago.

74. The system of claim 26, further comprising:
supplemental connector devices, said supplemental connector devices providing additional support for plural on-site self-sustainment subsystems selected from the group including ocean platforms for aquaculture, industry, commerce, transportation, agriculture, recreation, residential living, medicine, education, material handling cranes, energy intensive operations, protected shipping terminals at sea, airport runways and facilities, roads, fields for growing food crops, structures for piers, buildings, hospitals, and/or university facilities.

75. The system of claim 26 further including a discharge conduit that drives a deep-water pump for lifting additional deep water through a pipe.

76. The system of claim 26, wherein the body rotates on an axis due to relative motion between the body and the nearby fluid such that the rotation causes a pumping action to transport the fluid to a different strata level.

77. The system of claim 26, further including an air compression unit that reduces buoyancy of components in the system to submerge the system components below a wave zone during a major storm.

78. The system of claim 26, wherein the body is a double walled body comprised of an inner wall and an outer wall such that an elevated pressure between the walls increases body stiffness.

79. The system of claim 26, wherein the body has no nearby surface to provide partial enclosure of the material that is external to the body.

80. A system for inducing fluid flow, said system comprising a concentric water wheel along a conduit, the concentric water wheel taking power out of an external current as external blades of the concentric water wheel are driven by the material passing along the outside of the conduit, said external blades driving internal blades of the wheel to boost flow within said conduit, said external blades being connected to said internal blades in a concentric arrangement with said external blades separated from said internal blades by a seal, said seal allowing a shaft connecting the blades to rotate with minimal water loss through the seal.

81. A wave pump system for inducing fluid flow, said wave pump system comprising:
a wave-riding float, said wave-riding float being attached to
an upper pipe sleeve, said upper pipe sleeve having
a discharge opening, and
a submerged one-way valve mechanism, each one-way valve mechanism allowing fluid flow through said discharge opening in one direction only;
a separate concentric lower pipe sleeve, each lower pipe sleeve having a slightly different diameter from the upper pipe sleeve such that relative motion between said upper pipe sleeve and said lower pipe sleeve creates fluid flow due to suction; and
an anchoring mechanism attached to said lower sleeve, each anchoring mechanism thereby restraining the lower pipe sleeve from movement while said upper pipe sleeve rises and falls with each wave, thus causing relative sleeve motion and thus fluid flow between the two concentric sleeves and out the discharge opening.

82. A method for regulating planetary properties, said method comprising:
placing a body in proximity to a portion of a primary material that is regulated due to a relative motion between the body and the primary material to indirectly regulate a property of a more distant target material that subsequently comes in contact with the primary material and thereby achieves objectives from the set of hurricane abatement, atmospheric temperature regulation, regulation of average accumulation of precipitation in the form of ice, regulation of average ice sheet melting rate, regulation of planetary ice sheet size, regulation of the amount of solar reflection from ice on a planetary surface, regulation of planetary heat absorption due to planetary ice sheet size, further regulation of the average temperature of a planet by regulating the heat absorption due to reflection from planetary ice, regulation of planetary sea level by regulating the amount of planetary ice, and regulating Gulf Stream flow rate by regulating the size of a planetary ice sheet so that glaciers to not melt and accelerate their flow into the ocean thus blocking Gulf Stream flow due to fresh glacial melt water sitting atop the ocean and interfering with salt water currents.

83. The method of claim 82, further including a requirements and control algorithm, said requirements and control algorithm taking as input the latest published figures regarding the amount of carbon dioxide, methane and other temperature affecting gases reported to exist in the atmosphere, and producing as output the number of bodies and the relative velocity of those bodies needed to produce a desirable average atmospheric temperature, said algorithm using standard interpolation and extrapolation techniques based on a look-up table relating published ocean temperature correspondence with ice cap size in the historical record, said algorithm further using a control theory technique to determine a step response with an acceptable overshoot for proper re-stratification of planetary oceans, to achieve a desirable overall steady state water property regulation balance in the oceans over the millennia.

84. A method for balloting, said balloting method having encryption technology, voice recognition technology and cellular phone technology, to make possible the collection of one unique vote per individual, based on unique voice characteristics, for the purpose of making a collective decision.
